(19) United States
(12) Patent Application Publication
(10) Pub. No.: US 2004/0135875 A1
(43) Pub. Date: Jul. 15, 2004

(54) Optical write head, and method for assembling the same

(76) Inventor: Masahide Wakisaka, Osaka (JP)

Correspondence Address: RATNERPRESTIA, P O BOX 980, VALLEY FORGE, PA, 19482-0980, US

(21) Appl. No.: 10/476,745

(22) PCT Filed: May 15, 2002
(86) PCT No.: PCT/JP02/04681

(30) Foreign Application Priority Data
May 18, 2001 (JP) 2001-149679
Jul. 10, 2001 (JP) 2001-209050
Jul. 18, 2001 (JP) 2001-217649

(51) Int. Cl. B41J 2/45

(52) U.S. Cl. 347/238; 347/241

(57) ABSTRACT

A light-emitting element array is mounted on a light-emitting element mounting substrate and the light-emitting element mounting substrate is attached to a heat sink for discharging the heat from the light-emitting element array. The heat sink is fixed to a lens-supporting member for supporting a rod lens array at specific intervals along the longitudinal direction of the lens-supporting member. And a driver substrate having an electronic device for driving the light-emitting element array mounted on it is attached to the lens-supporting member. Aligning pieces and adjusting plates are alternately adhesively fixed to a side face of the rod lens array in the longitudinal direction of the rod lens array, and aligning piece bearing bases are adhesively fixed at opposite positions of the lens-supporting member to the aligning pieces. An aligning piece fits onto an aligning piece bearing base and is slid by an angular adjustment of an adjusting pole provided on the adjusting plate to make the optical axis of a rod lens variable.

### TECHNICAL FIELD

The present invention relates to an optical write head which is used in an electrophotographic printer or the like and collects and projects light outputted from a light-emitting element array by means of a lens array onto a photosensitive member.

### BACKGROUND ART

In recent years, an electrophotographic printer has been demanded to have high resolution, colorization and high-speed printing in performance due to the increase of performance requirements for an electrophotographic image. For colorization, ordinarily a multicolor reproduction can be realized by using toner of 4 colors of yellow, magenta, cyan and black and adjusting the mixture ratio of these four colors. In order to obtain high performance in printing speed, a 4-unit tandem system having an optical write head and a photosensitive drum for each color is adopted, and in order to make a good color reproduction, it is necessary to transfer each color toner to a recording medium on a transfer belt at an accurate position.

FIG. 1 shows an example of a conventional optical write head. FIG. 1 is a sectional view of a conventional optical write head in a direction perpendicular to the longitudinal direction of the head. In the conventional optical write head, a plurality of light-emitting element array chips 24 each having light-emitting elements arranged in row are mounted in the main scanning direction on a light-emitting element mounting substrate 23, and a rod lens array 21 having rod lenses arranged in row in the longitudinal direction of the head is fixed on the optical axis of output light of each of these light-emitting elements by a plastic cover 22. And on the optical axis of the rod-lens array there is provided a photosensitive drum 25. And the peripheral corners of the light-emitting element mounting substrate 23 are engaged with the end part of the leg portion of the plastic cover 22.

The rod lens array 21 collects light of the light-emitting elements and irradiates the photosensitive drum 25 with the light. The surface of the photosensitive drum 25 is changed in electric potential in parts irradiated with light and forms a latent image.

An optical write head used in a high-resolution electrophotographic printer needs to make the positional accuracy of image formation along the main direction of a light-emitting element array chip be 30 μm or less, and in order to accurately align a rod lens array with a substrate having a light-emitting element array chip mounted on it, it is required to make remarkably high the accuracy in shape of a plastic cover.

However, since a conventional optical write head described above is poor in shape accuracy of a plastic cover for supporting a rod lens array, it has a problem that the optical axis of the rod lens array 21 for collecting light of the light-emitting elements is deviated and a light spot row to be projected onto the photosensitive drum is slipped in the sub scanning direction.

And as shown in FIG. 3, in a conventional optical write head, since the accuracy in linearity of mounted position of a chip in a light-emitting element mounting substrate 23 is inferior, the chip is sometimes slipped from position A at which the chip is to be properly mounted to position B. Due to this, a light spot row may be slipped from position A′ to position B′, as shown in FIG. 4. FIG. 5 is a diagram showing a positional slippage in image formation in the sub scanning direction of each light-emitting element array chip. FIG. 5 shows a positional slippage in image formation of a light spot row of each of 34 light-emitting element array chips, said each light spot row being projected onto a photosensitive drum, and it is seen that the positional slippage ranges from −20 μm to 45 μm.

Therefore, the structure of a conventional optical write head described above makes it difficult to transfer each color toner to the same position and causes the color reproducibility to be deteriorated.

In order to solve such a problem that a light spot row to be projected onto a photosensitive drum is slipped in the sub scanning direction, an LED head described in Japanese Patent Laid-Open Publication No.Hei 11-001,018 prevents the optical axis of a rod lens from being inclined by means for positioning a lens holder by forming a groove or notch in a base portion for supporting an LED array, providing a projection on the lens holder for supporting the rod lens array, and inserting the projection into the groove or notch. In order to satisfy a required accuracy for a means of positioning a lens holder for holding a rod lens array, however, it is necessary to accurately make a projection to be provided on the lens holder and a groove or notch to be provided in a base portion. Since a lens holder is typically made of molded plastic and a base portion is made of pressed sheet metal, it is difficult in practice to make each component with high accuracy in shape.

And in order to solve a problem that a light spot row is slipped in the sub scanning direction, there has been proposed a method of printing a specific pattern, measuring the quantity of slippage of the printed pattern and controlling the light emitting time of each chip or each light-emitting element for the quantity of slippage. However, since it is necessary to derive a compensation value from a printed matter, the complexity of an adjusting process increases the cost.

And in a conventional optical write head described above, as a substrate to have a light-emitting element array chip mounted on it, there is ordinarily used a glass-epoxy substrate being a composite material of glass fiber mat and epoxy resin. Since the glass-epoxy substrate is a material hard to conduct heat (the heat conductivity is 0.38 W/mK), it is difficult to discharge heat from a light-emitting element chip. And a plastic cover is of a hermetically sealing structure having a light shielding function to prevent an outside light from entering inside the head. Due to this, the temperature rise of the light-emitting element chip is increased. The optical output of a light-emitting element chip has a large dependency on temperature and the quantity of emitted light is reduced by temperature rise. It is known that the quantity of emitted light of a Ga As-based light-emitting element is reduced by 0.5% due to a temperature rise of 1° C. of the chip. Reduction in quantity of emitted light brings reduction in printing density and this brings a fatal problem to a printer.

And with regard to a conventional optical write head, around a photosensitive drum there are a corona discharge unit, for example, for charging the photosensitive drum, a developing unit for developing an image by setting toner on a latent image on the photosensitive drum, a transfer unit for transferring the toner on the photosensitive drum to a transfer belt, and the like. It is very hard to arrange the respective units of charging, latent image formation, development and transfer in a small space and it is naturally necessary to make the width of the head be the irreducible minimum.

FIG. 6 is a diagram showing an example of an optical write head designed to be narrow in head width. An optical write head shown in FIG. 6 comprises a lens-supporting member 32 for supporting a rod lens array 31, a light-emitting element mounting substrate 33 and a substrate stand 35 for mounting a driver substrate 34 on it. The light-emitting element mounting substrate 33 has a light-emitting element array chip 36 mounted on it, and the light-emitting element mounting substrate 33 and the driver substrate 34 are electrically connected to each other by a flexible cable 37. And the lens-supporting member 32 and the substrate stand 35 are fixed in position by using joining members or by inserting a filling and fixing agent between both of them at the end parts of them in the longitudinal direction.

The optical write head shown in FIG. 6 has a structure in which the light-emitting element mounting substrate 33 having the light-emitting element array chip 36 mounted on it is mounted on the substrate stand 35 and the driver substrate 34 having a heat generating object is also mounted on the substrate stand 35 and, therefore, the heat energy from the driver substrate 34 is propagated through the substrate stand 35 and the light-emitting element mounting substrate 33 to the light-emitting element array chip 36.

There is therefore a problem that a light-emitting element array chip is influenced not only by the heat energy generated by the light-emitting elements themselves but also by the heat energy generated by such electronic devices as ICs mounted on the driver substrate, and brings variation in density of a printed image.

And FIGS. 7 and 8 each show an example of fixing a lens-supporting member and a substrate stand in position. In FIG. 7, the lens-supporting member 32 and the substrate stand 35 are fixed to each other by joining members 38 and solder 39. In FIG. 8, the lens-supporting member 32 and the substrate stand 35 are fixed to each other by inserting a filling and fixing agent 40 into a gap. FIGS. 7 and 8 show only one end face of an optical write head but the same supporting and fixing operation is also performed at the other end face. That is to say, in the conventional optical write head shown in FIG. 6, the lens-supporting member 32 and the substrate stand 35 are fixed to each other only at both ends in the longitudinal direction of the lens-supporting member 32 and the substrate stand 35.

Accordingly, there is a problem that fixing both the members to each other at only both ends causes both the members to have their own natural frequencies respectively and makes it impossible for them to keep a sufficient strength, and therefore they may vibrate in resonance with vibration in another process and lower the natural frequency of the head itself and the head itself may vibrate or become a noise source.

### DISCLOSURE OF INVENTION

An object of the present invention is to provide an optical write head in which no light-emitting element is influenced by heat generation by such an electronic device as a driving IC and the like mounted on a driver substrate and which can raise the natural frequency of its structure.

Another object of the present invention is to provide an optical write head preventing a light spot row from slipping in the sub scanning direction when the output light of light-emitting elements is projected through rod lenses onto a photosensitive drum.

A further other object of the present invention is to provide an optical write head which is capable of suppressing the temperature rise of an LED chip and arranging its optical components with high accuracy and provide a method for assembling the same.

A first aspect of the present invention is characterized by an optical write head for collecting and projecting the output light from a light-emitting element array onto a photosensitive member by means of a lens array having lenses arranged in a row, wherein the light-emitting element array is mounted on a light-emitting element mounting substrate, the light-emitting element mounting substrate is attached to a heat sink for discharging heat from the light-emitting element array, the heat sink is clamped and fixed by push bolts and pull bolts to a lens-supporting member for supporting the lens array at specific intervals in the longitudinal direction of the lens-supporting member, and a driver substrate having an electronic device for driving the light-emitting element array mounted on it is attached to the lens-supporting member.

And a second aspect of the present invention is characterized by an optical write head for collecting and projecting the output light from a light-emitting element array onto a photosensitive member by means of a lens array having lenses arranged in a row, said optical write head making the optical axis angle of lens variable by being provided with one optical axis adjusting means or two or more optical axis adjusting means at specific intervals in the longitudinal direction of the lens array between the abutting faces of the lens array and the lens-supporting member for supporting the lens array.

The optical axis angle adjusting means comprises an adjusting plate for adjusting the angle of the optical axis of a lens, the adjusting plate being fixed to the abutting face of the lens array, an aligning piece fixed to the abutting face of the lens array with a specific space relative to the adjusting plate, and an aligning piece bearing base fixed to the abutting face of the lens-supporting member at a position opposite to the aligning piece, wherein the aligning piece is fitted into the aligning piece bearing base and makes the optical axis angle of a lens variable by being slid by an angular adjustment of the adjusting plate.

A third aspect of the present invention is characterized by an optical write head comprising a lens array on the optical axis of light emitted by a light-emitting element of a light-emitting element array and further a heat sink made of a metal material under a substrate having the light-emitting element array mounted on it, wherein the heat sink is provided with first reference holes at specific intervals in the longitudinal direction of the heat sink, the substrate is provided with second reference holes at the same positions to the first reference holes in the longitudinal direction of the substrate, and the first reference holes and the second reference holes are aligned with each other so that the lens array and the light-emitting element array coincide in optical axis with each other.

Or the invention is characterized by a fact that the heat sink is provided with first reference holes at both end parts in the longitudinal direction of the heat sink, the substrate is provided with second reference holes at both end parts in the longitudinal direction of the substrate and is provided with metal patterns at specific intervals or a continuous metal pattern at an edge part of the substrate, and the first reference holes and the second reference holes are aligned with each other so that the lens array and the light-emitting element array on the substrate coincide in optical axis with each other.

### BRIEF DESCRIPTION OF DRAWINGS

FIG. 1 is a sectional view taken along a direction perpendicular to the longitudinal direction of a conventional optical write head.

FIG. 2 is a diagram showing a state where a light spot row projected onto a photosensitive drum is slipped in the sub scanning direction due to a plastic cover being inferior in shape accuracy.

FIG. 3 is a diagram showing a state where a light-emitting element array chip is mounted on a substrate.

FIG. 4 is a diagram showing a state where a light spot row projected onto a photosensitive drum is slipped in the sub scanning direction due to a positional slippage of a light-emitting element array mounted on a substrate.

FIG. 5 is a diagram showing a positional slippage of image formation in the sub scanning direction of each of light-emitting element array chips.

FIG. 6 is a diagram showing an example of a conventional optical write head of an electrophotographic system.

FIG. 7 is a diagram showing an example of fixing a lens-supporting member and a substrate stand in position.

FIG. 8 is a diagram showing an example of fixing a lens-supporting member and a substrate stand in position.

FIG. 9 is a sectional view showing a first embodiment of an optical write head of the present invention taken along a direction perpendicular to the longitudinal direction of the head.

FIG. 10 is a sectional view of a heat sink taken along a direction perpendicular to the longitudinal direction of it.

FIG. 11 is a perspective view showing a state where a light-emitting element mounting substrate is fixed to a heat sink by means of bolts.

FIG. 12 is a perspective view showing a positional relation between a rod lens array and a light-emitting element array chip.

FIG. 13 is a sectional view showing a positional relation between a rod lens array and a light-emitting element array chip taken along a direction perpendicular to the longitudinal direction of the head.

FIG. 14 is a perspective view showing a lens-supporting member and a heat sink.

FIG. 15 is a partial sectional view showing a lens-supporting member and a heat sink.

FIG. 16 is a perspective view showing a heat sink and a lens-supporting member.

FIG. 17 is a diagram showing a state where a heat sink is fixed to a lens-supporting member by means of an adhesive agent.

FIG. 18 is an exploded perspective view of a rod lens array and a lens-supporting member showing a second embodiment of an optical write head of the present invention.

FIG. 19 is a sectional view of an aligning piece part of an optical write head taken along a direction perpendicular to the longitudinal direction of the head.

FIG. 20 is a sectional view of an adjusting plate part of an optical write head taken along a direction perpendicular to the longitudinal direction of the head.

FIG. 21 is a side view showing a state where an aligning piece is mounted on a rod lens array.

FIG. 22 is a diagram showing a state where an aligning piece bearing base is fixed to a side face of a lens-supporting member by means of a positioning rib.

FIG. 23 is a side view showing a state where a heat sink having light-emitting element array chip mounting substrate mounted on it is mounted on an optical axis adjusting apparatus.

FIG. 24 is a side view showing a state where a lens-supporting member is mounted on a heat sink.

FIG. 25 is a perspective view showing a state where a lens-supporting member is mounted on a heat sink.

FIG. 26 is a side view showing a state where an optical write head is mounted on an optical axis adjusting apparatus.

FIG. 27 is a diagram showing a variation example of the present invention.

FIG. 28 is a diagram showing a variation example of the present invention.

FIG. 29 is a diagram showing a variation example of the present invention.

FIG. 30 is a diagram showing a variation example of the present invention.

FIG. 31 is a sectional view showing a third embodiment of an optical write head of the present invention taken along a direction perpendicular to the longitudinal direction of the head.

FIG. 32A is a plan view showing a state where an FPC is attached to a heat sink.

FIG. 32B is a sectional view taken along line A-A′ of FIG. 32A.

FIG. 33 is a perspective view showing an example of a method of aligning an FPC with a heat sink.

FIG. 34 is a schematic sectional view showing a jig, an FPC and a heat sink of another example of an aligning method.

FIG. 35 is a sectional view showing the structure of an FPC.

FIG. 36 is a diagram showing an example of an optical write head using an FPC shown in FIG. 32A.

FIG. 37A is a plan view showing a state where an FPC is attached to a heat sink.

FIG. 37B is a sectional view taken along line B-B′ of FIG. 37A.

FIG. 38 is a schematic sectional view of a jig, an FPC and a heat sink showing an example of an aligning method.

FIG. 39A is a plan view showing a state where an FPC is attached to a heat sink.

FIG. 39B is a sectional view taken along line C-C′ of FIG. 39A.

FIG. 40 is a diagram showing an example of an optical write head using an FPC shown in FIG. 39A.

FIG. 41 is a diagram showing an equivalent circuit of a self-scanning light-emitting element array chip having a structure in which a shift portion and a light emitting portion are separated from each other.

FIG. 42 is a perspective view showing an example of the composition of a plastic erecting unity-magnification lens array.

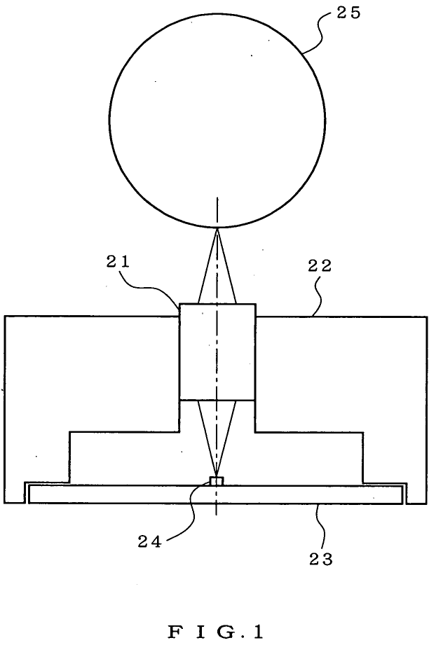

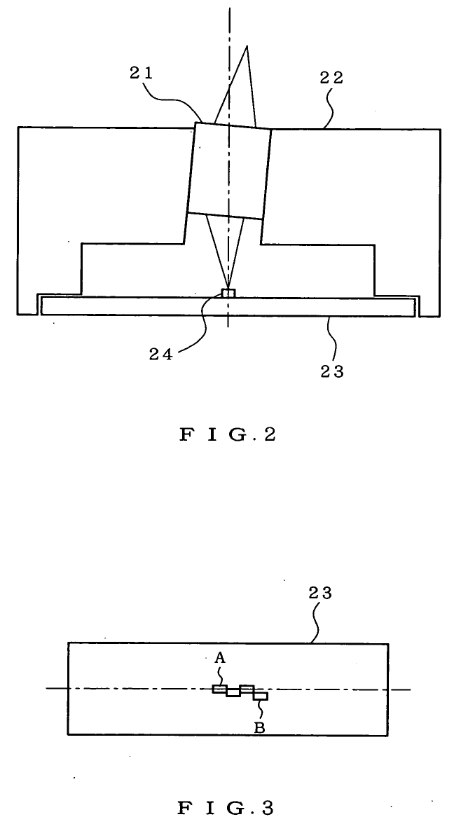

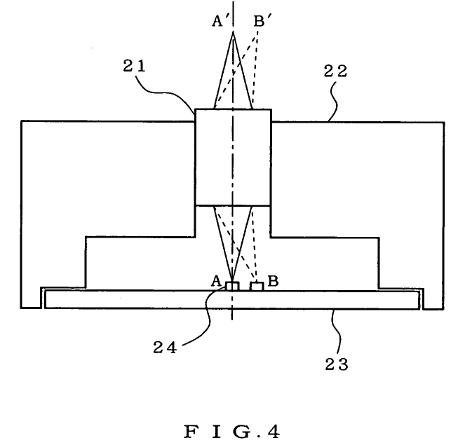

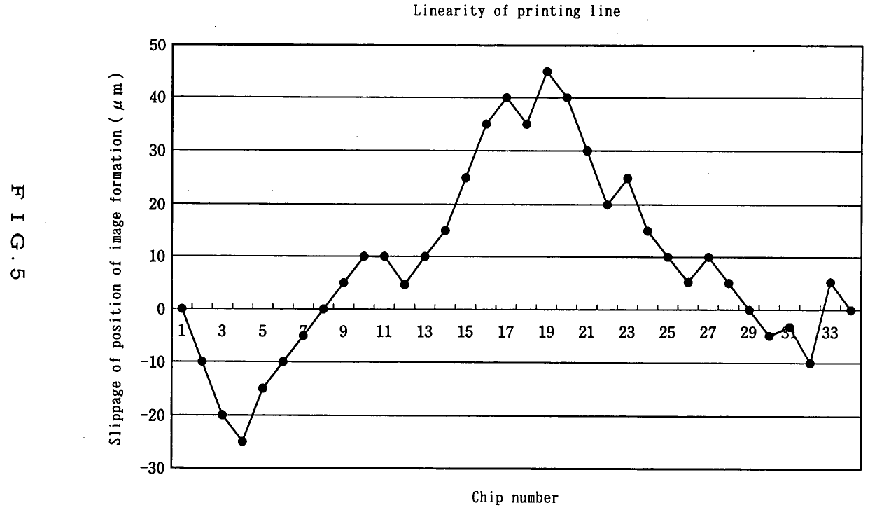

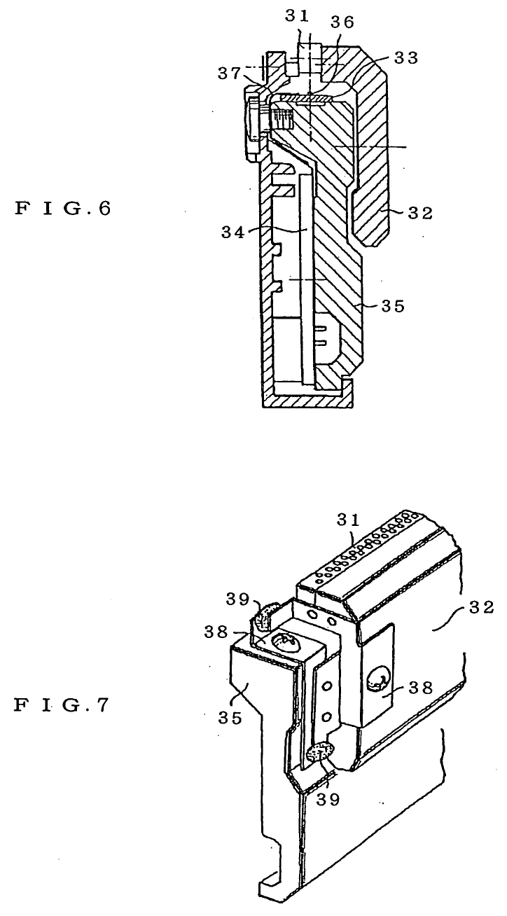

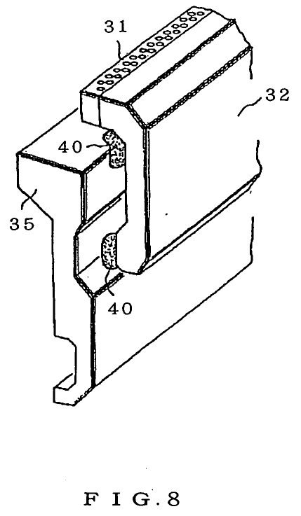

### BEST MODE FOR CARRYING OUT THE INVENTION

Next, a first embodiment of the present invention is described with reference to the drawings.

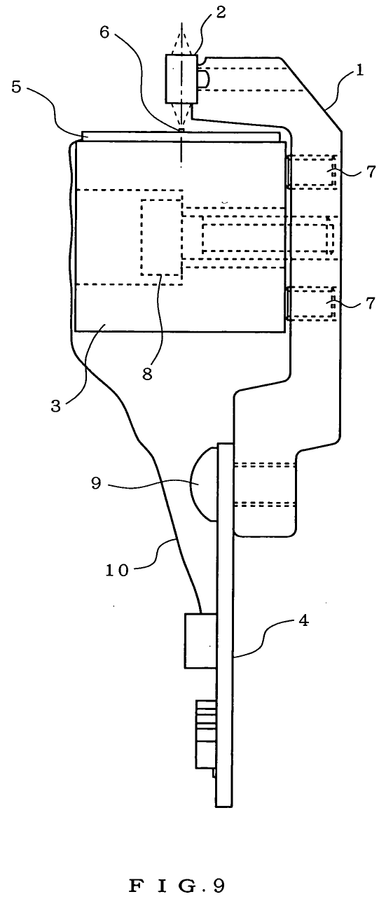

FIG. 9 is a sectional view showing a first embodiment of an optical write head of the present invention taken along a direction perpendicular to the longitudinal direction (main scanning direction) of the head.

A rod lens array 2 having erecting unity-magnification rod lenses arranged in a row is attached to a lens-supporting member 1 by means of adhesion or the like and a heat sink 3 is adjusted in position and fixed by push bolts 7 and pull bolts 8, and a driver substrate 4 is fixed by bolts 9.

A light-emitting element mounting substrate 5 is adhesively fixed to the heat sink 3 and a plurality of light-emitting element array chips 6 each having light-emitting elements arranged in a row are mounted so that the optical axis of light outputted from a light-emitting element coincides with the axis center of a rod lens.

Such an electronic device as an IC or the like for driving a light-emitting element is mounted on the driver substrate 4, and the driver substrate 4 and the light-emitting element mounting substrate 5 are electrically connected to each other by a flexible cable 10.

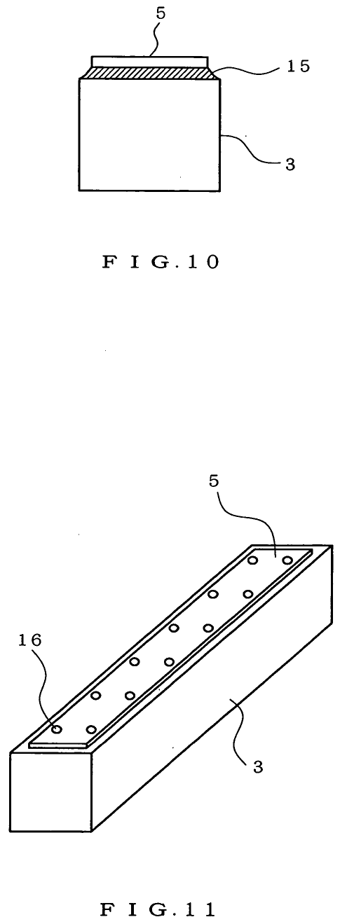

FIG. 10 is a sectional view of the heat sink taken along a direction perpendicular to the longitudinal direction of it. As shown in FIG. 10, the light-emitting element mounting substrate 5 is attached to the heat sink 3 by an adhesive agent 15. The heat sink 3 has an action of discharging the heat generated by a light-emitting element array chip mounted on the light-emitting element mounting substrate 5.

The temperature around the head of a printer during operation is about 60° C. and depends on the ambient temperature (0 to 30° C.) of a spot where the printer is installed. That is to say, the temperature of a head is variable in a range of 0° C. to 60° C.

Under such a condition, in case of assembling a heat sink and a light-emitting element mounting substrate which are made of materials being different in coefficient of linear expansion from each other, a strain caused by the difference in coefficient of linear expansion is generated between the heat sink and the light-emitting element mounting substrate, and this strain gives a stress to the adhesive interface between the heat sink and the light-emitting element mounting substrate and exfoliates the adhesive layer or bends the heat sink due to a bimetal phenomenon.

Therefore, it is preferable that the heat sink and the light-emitting element mounting substrate are respectively made of materials being approximate in coefficient of linear expansion to each other, and the following combinations are conceivable as the materials for the heat sink and the light-emitting element mounting substrate.

TABLE 1

| Material for a light-emitting | |
|---|---|
| element mounting substrate | Material for a heat sink |
| Ceramic substrate | Iron, Nickel alloy |
| Glass-epoxy substrate | Aluminum, Inorganic filler |
| | containing resin, Mineral |
| | filler containing resin |
| Iron substrate | Iron, Stainless (SUS430 system) |

This embodiment uses a ceramic substrate as a light-emitting element mounting substrate and uses a nickel alloy as a heat sink.

Although the above-mentioned embodiment attaches the light-emitting element mounting substrate to the heat sink by means of an adhesive agent, the light-emitting element mounting substrate may be fixed to the heat sink by bolts. FIG. 11 is a perspective view showing a state where the light-emitting element mounting substrate is fixed to the heat sink by bolts. The light-emitting element mounting substrate 5 is fixed to the heat sink 3 at end parts in a direction perpendicular to the longitudinal direction of the substrate by bolts 16 at specific intervals in the longitudinal direction.

The pitch between bolts in case of fixing the light-emitting element mounting substrate 5 to the heat sink 3 by means of bolts 16 is preferably 20 mm to 60 mm.

An optical write head according to the first embodiment has a structure in which a driver substrate is attached to a lens-supporting member rather than a heat sink (substrate stand). Therefore, since the heat generated by such an electronic device as an IC or the like mounted on the driver substrate is hard to be transmitted to a light-emitting element array on the light-emitting element mounting substrate, it is possible to stabilize the quantity of emitted light of light-emitting elements.

Next, a method of adjusting the optical axis of light outputted from a light-emitting element is described.

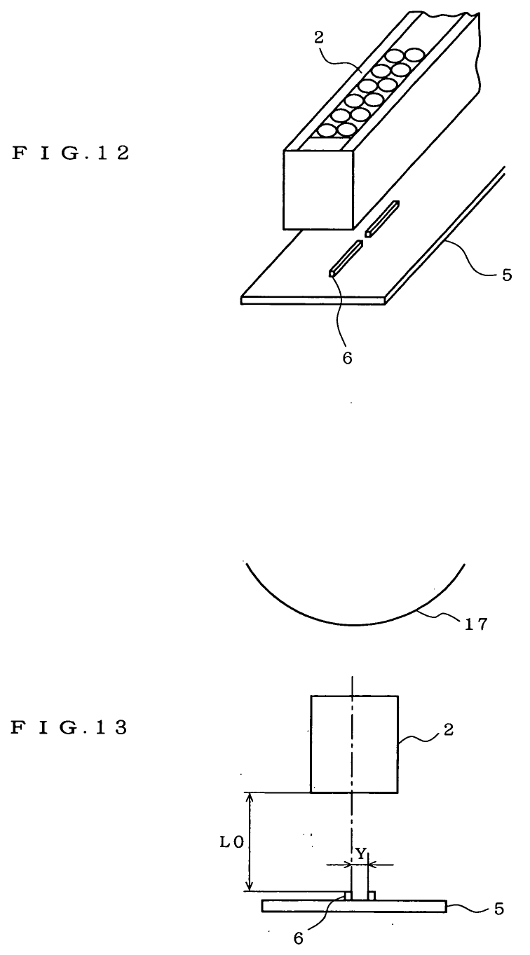

FIG. 12 is a perspective view showing the relation in position between a rod lens array and a light-emitting element array chip. A plurality of light-emitting element array chips 6 are arranged in a row on the light-emitting element mounting substrate 5 in the longitudinal direction of the substrate. A light-emitting element array chip 6 is composed of a plurality of light-emitting elements arranged in a row.

FIG. 13 is a sectional view showing the relation in position between the rod lens array and the light-emitting element array chips taken along a direction perpendicular to the longitudinal direction of the head. A light-emitting element array chip 6 is mounted on a light-emitting element mounting substrate 5 and a rod lens array 2 having rod lenses arranged in a row in the longitudinal direction of the head is fixed and arranged on the optical axis of light outputted from the light-emitting element array chip 6 by a lens-supporting member. A photosensitive drum 17 is arranged above the rod lens array 2.

A rod lens collects and irradiates light of a light-emitting element to the photosensitive drum 17. The surface of the photosensitive drum 17 is changed in electric potential in parts irradiated with light to form a latent image.

Since a rod lens used in an optical write head of high resolution has the depth of image formation (LO) of about ±40 μm, said depth of image formation being shallow, even a slight deviation in position of the rod lens may expand a spot diameter at a latent image position on the photosensitive drum or may generate a virtual image. And a slippage in optical axis between a light-emitting element and a rod lens as shown by Y in FIG. 13 generates irregularity in quantity of light. A light-emitting element and a rod lens therefore need to be adjusted with high accuracy in direction of working distance and optical axis of the lens.

As a measure against such a problem, there is a method of fixing the end parts in the longitudinal direction of a lens-supporting member and a heat sink with solder. However, since this method fixes the respective components only at both ends of them for a structural problem, it lowers their natural frequencies. To fix them only at both ends makes it difficult to keep a sufficient fixing strength.

In order to solve the above-mentioned problems, the following means is used in the first embodiment.

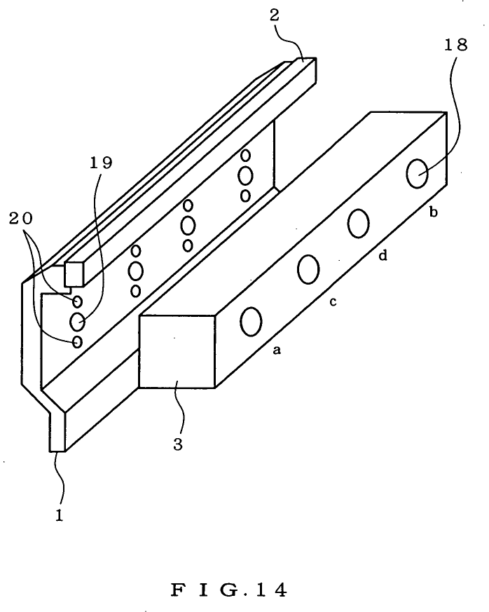

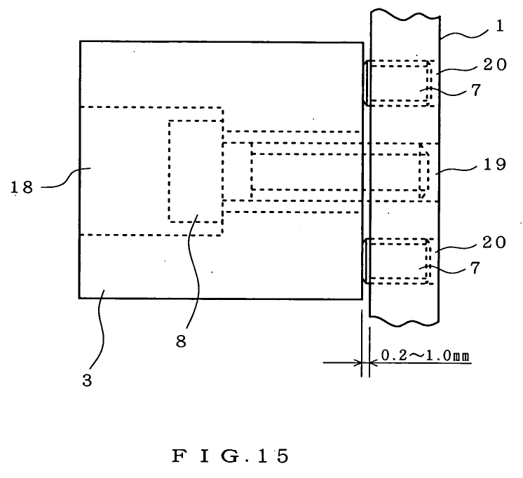

FIG. 14 is a perspective view showing a lens-supporting member and a heat sink, and FIG. 15 is a partial sectional view of a lens-supporting member and a heat sink. The heat sink 3 is provided with holes 18 for attaching pull bolts at intervals of 70 to 150 mm in the longitudinal direction of the heat sink 3. The lens-supporting member 1 is also provided with tapped holes 19 for pull bolts at the same intervals as the holes 18 for attaching pull bolts of the heat sink 3.

And the lens-supporting member 1 is provided with two tapped holes 20 for push bolts with a tapped hole 19 for a pull bolt between them. It is important that the position of a tapped hole 20 for a push bolt and the position of a tapped hole 19 for a pull bolt are the same as each other in the longitudinal direction (scanning direction) of the lens-supporting member 1. Because otherwise a pressing force by the push bolts 7 and the pull bolt 8 gives an unbalanced load to the lens-supporting member 1 and the heat sink 3 and thereby deforms the members. Using two push bolts is for the purpose of adjusting the inclination of the optical axis and preventing the inclination of the optical axis from varying.

The gap between the heat sink 3 and the lens-supporting member 1 is preferably about 0.2 to 1 mm after adjustment of the optical axis.

Next, a method of fixing a heat sink and a lens-supporting member in position using push bolts and pull bolts is described.

The method sets a light-emitting element position at the optical axis center, adjusts the position of image formation to a proper position, and then inserts a push bolt 7 into a tapped hole 20 for push bolt at the lens-supporting member 1 side, gradually screws in and moves the push bolt 7 to the position where the fore-end of the push bolt comes in contact with the heat sink 3.

At this time the method first adjusts the push bolts 7 at both end part sides in the longitudinal direction of the lens-supporting member 1, and then adjusts the push bolts 7 in the middle side in order. For example, the method performs adjustment in order of a, b, c and d in FIG. 14. A hexagon socket head cap screw is preferably used as a push bolt 7. And the push bolt 7 has preferably a sharp fore-end.

Next, the method inserts a pull bolt 8 into a hole 18 for attaching a pull bolt at the heat sink 3 side, screws in the fore-end of the pull bolt 8 into a tapped hole 19 for a pull bolt of the lens-supporting member 1 and tightly screws in the pull bolt 8 and thereby fixes the heat sink 3 and the lens-supporting member 1 to each other.

In this way, since the first embodiment fixes the heat sink and the lens-supporting member to each other not only at both end points in the longitudinal direction of them but also at the middle points, it makes the heat sink and the lens-supporting member into one body, increases the geometrical moment of inertia and thereby can raise the natural frequency.

Since a natural frequency is represented by the following expression, the natural frequency can be made higher by increasing the geometrical moment of inertia.

[Numeric Expression 1]

ω₀=(22.4/L²)√(EI/ρ)

E: Young's modulus (kg/mm²)

I: Geometrical moment of inertia (cm⁴)

L: Length of beam (cm)

ρ: Density of beam (10³×kg/m³)

ω₀: Natural frequency (of the primary transverse vibration)

Here, constant 22.4 is a value in case of a beam fixed at both ends. This constant is 9.87 in case of a beam supported at both ends.

And since an optical write head according to the first embodiment fixes the heat sink and the lens-supporting member to each other not only at both end points in the longitudinal direction of them but also at the middle points, it can keep a sufficient mechanical strength.

Further, since the optical write head according to the first embodiment has a structure which regulates the heat sink in position by means of push bolts and fixes it by means of pull bolts, the heat sink can be set at an optional position.

Although the heat sink and the lens-supporting member are fixed to each other by means of push bolts and pull bolts in the above-mentioned embodiment, the heat sink and the lens-supporting member may be fixed to each other by means of an adhesive agent.

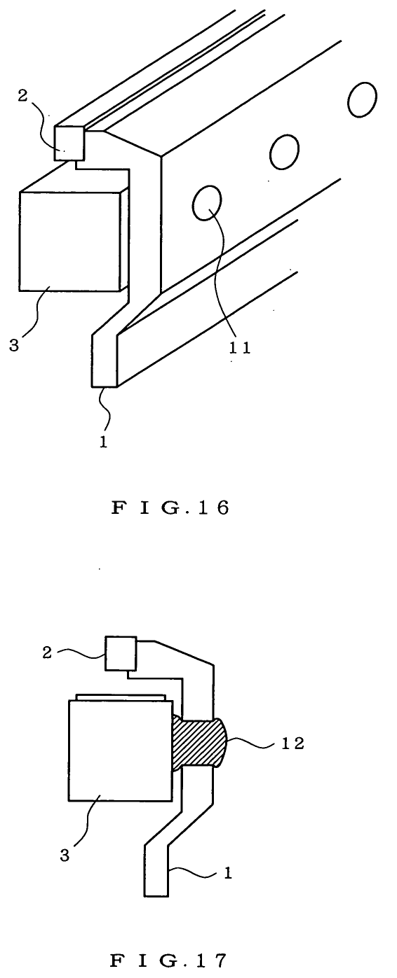

FIG. 16 is a perspective view of a heat sink and a lens-supporting member, and FIG. 17 is a diagram showing a state where the heat sink is fixed to the lens-supporting member by means of an adhesive agent. As shown in FIG. 16, the lens-supporting member 1 is provided with filler inserting holes 11 at intervals of 70 to 150 mm in the longitudinal direction of the lens-supporting member 1.

After performing an optical axis adjustment, the method injects and hardens a hardening filler 12 as an adhesive agent into the filler inserting holes 11 of the lens-supporting member 1 as shown in FIG. 17, and thereby fixes the heat sink 3 to the lens-supporting member 1. As a hardening filler 12, for example, a UV hardening adhesive agent is used and is hardened by UV irradiation.

Since there is a danger that an adhesive agent infiltrates and contaminates the surface of a light-emitting element mounting substrate at the time of injecting the adhesive agent, it is desirable to use an adhesive agent of 100 poises or more in viscosity.

And a moisture hardening adhesive agent, a thermosetting adhesive agent or a two-fluid hardening adhesive agent may be used instead of a UV hardening adhesive agent. Further, filler inserting holes may be provided in the heat sink side.

Since the invention related to the above-mentioned first embodiment can fix the heat sink and the lens-supporting member to each other at a plurality of spots, it is possible to make the lens-supporting member and the heat sink into substantially one body in structure, raise the natural frequency and prevent occurrence of vibration to be caused by resonance or the like. And it is possible also to increase the mechanical strength of the head.

And the driver substrate is attached to the lens-supporting member, the light-emitting element mounting substrate is attached to the heat sink and further the thermal contact parts between the heat sink and the lens-supporting member are only pull bolts and push bolts and as a result there is substantially no thermal conduction between both of the heat sink and the lens-supporting member, and therefore the heat energy of the driver substrate does not conduct to the light-emitting element mounting substrate. Accordingly, it is possible to stabilize the quantity of light of the light-emitting elements.

Next, a second embodiment of the present invention is described with reference to the drawings.

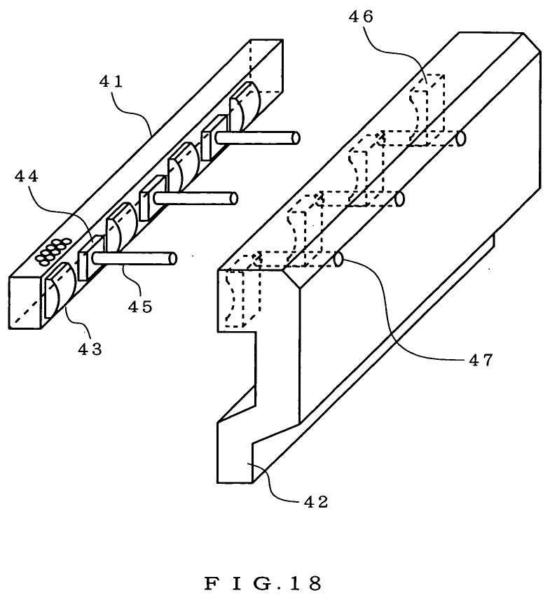

FIG. 18 is an exploded perspective view of a rod lens array and a lens-supporting member showing a second embodiment of the present invention. As shown in FIG. 18, on a side face of a rod lens array 41 having rod lenses arranged in a row on it, aligning pieces 43 and adjusting plates 44 are adhesively fixed alternately with each other at intervals of 20 to 65 mm in the longitudinal direction (main scanning direction) of the rod lens array 41.

Aligning piece bearing bases 46 are adhesively fixed, at positions facing the aligning pieces 43, on the abutting face of a lens-supporting member 42 for supporting the rod lens array 41.

A convex portion in the shape of a circular arc having the center of the rod lens array 41 as its center is provided on each of the aligning pieces 43, and a concave portion in the shape of a circular arc which has the center of the rod lens array 41 as its center and is to be fitted onto the convex part of the aligning piece 43 is provided on each of the aligning piece bearing bases 46.

The adjusting plate 44 is provided with adjusting poles 45 for adjusting the angle of the optical axis of the rod lens array 41, and the lens-supporting member 42 is provided with through holes 47 for receiving the adjusting poles 45.

The aligning piece 43 is fitted into the aligning piece bearing base 46 and is slid by angular adjustment of the adjusting pole 45 to make the optical axis of a rod lens variable.

The aligning piece 43 and the adjusting plate 44 are made of metal or resin material. And in case of making the aligning piece 43 and the adjusting plate 44 of resin, they may be formed by injection molding.

The lens-supporting member 42 is formed out of a metal material, and the aligning piece bearing base 46 is formed out of a metal or resin material.

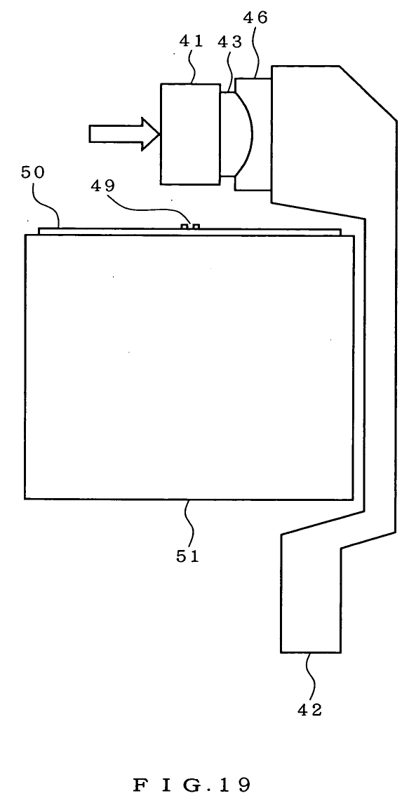

FIG. 19 is a sectional view of an aligning piece part of an optical write head taken along a direction perpendicular to the longitudinal direction of the head. A plurality of light-emitting element array chips 49 each having light-emitting elements arranged in a row are arranged in the main scanning direction on the optical axis of incident light of a rod lens array 41. A light-emitting element array chip 49 is mounted on a light-emitting element mounting substrate 50, and the light-emitting element mounting substrate 50 is attached to a heat sink 51 in order to prevent lowering of the quantity of emitted light caused by temperature rise of a light-emitting element array chip 49 by discharging the heat from the light-emitting element array chip 49. And a photosensitive drum (photosensitive member) not illustrated is arranged on the optical axis of output light of the rod lens array 41. The light-emitting element array chip 49 is preferably a self-scanning light-emitting element array chip.

As shown in FIG. 19, aligning pieces 43 are fixed on a side face of a rod lens array 41 and aligning piece bearing bases 46 are fixed, at positions facing the aligning pieces 43, on the abutting face of a lens-supporting member 42 for supporting the rod lens array 41. A convex portion in the shape of a circular arc having the center of the rod lens array 41 as its center is provided on each of the aligning pieces 43, and a concave portion in the shape of a circular arc which has the center of the rod lens array as its center and is to be fitted onto the convex portion of the aligning piece 43 is provided on each of the aligning piece bearing bases 46. An aligning piece 43 and an aligning piece bearing base 46 are fitted onto each other with their convex and concave portions, and the aligning piece 43 is slid on the fitting face with the aligning piece bearing base 46.

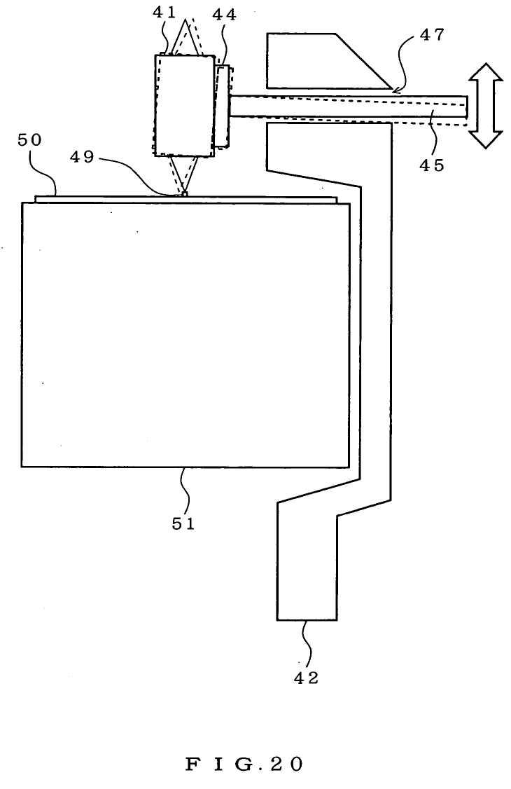

FIG. 20 is a sectional view of an adjusting plate part of an optical write head taken along a direction perpendicular to the longitudinal direction of the head. As shown in FIG. 20, an adjusting plate 44 is fixed on a side face of a rod lens array 41 and an adjusting pole 45 for adjusting the angle of the optical axis of a rod lens is provided on the adjusting plate 44. The adjusting pole 45 is arranged so as to pass through a through hole 47 provided in a lens-supporting member 42 and protrude its fore-end outside the optical write head.

When the fore-end of the adjusting pole 45 is moved in the direction of arrow of FIG. 20, the optical axis of a rod lens is moved by a fact that the aligning piece 43 slides on the fitting face and the position of image formation on the photosensitive drum not illustrated is moved in the sub scanning direction. Therefore, it is possible to adjust the angle of the optical axis of a rod lens by means of the adjusting pole 45 so that a light spot row projected onto the photosensitive drum is not slipped in the sub scanning direction.

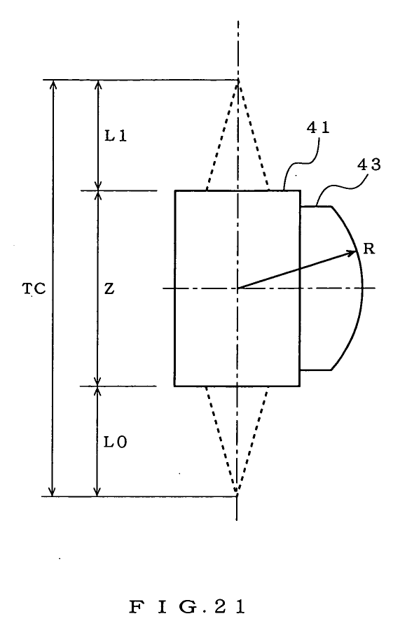

FIG. 21 is a side view showing a state where an aligning piece 43 is attached to a rod lens array. In case that an aligning piece 43 is made of resin, it is preferable that the aligning piece 43 is 1.5 mm to 4 mm in thickness in consideration of the accuracy of resin molding and is in the shape of a circular arc of R in radius having the center of a rod lens as its center. In FIG. 21, L0 is the working distance between a rod lens and a light-emitting element, Z is the length of the rod lens and L1 is the distance between the rod lens and the position of spatial image formation.

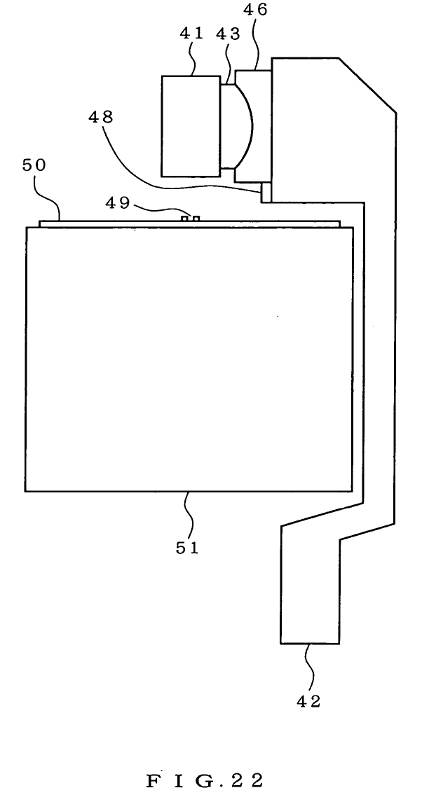

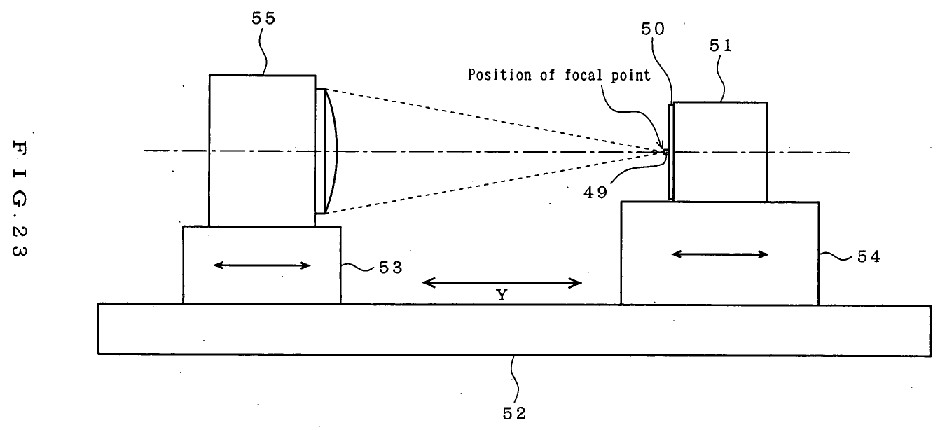

An aligning piece bearing base is adhesively fixed to the lens-supporting member at a position facing an aligning piece, and at this time, the centers of circular arcs of a plurality of aligning piece bearing bases 46 may be aligned in a line with one another by providing ribs 48 for positioning the aligning piece bearing bases 46 as shown in FIG. 22 in advance at specific intervals in the main scanning direction on a side face of the lens-supporting member and adhesively fixing the aligning piece bearing bases 46 by means of these positioning ribs 48.

And the lens-supporting member is provided with through holes so that adjusting poles provided on the adjusting plates do not interfere with the through holes, and in this case these through holes each may be a hole being somewhat larger in diameter or an elliptic hole having the major axis in the direction of movement of the adjusting pole so that the through holes and the adjusting poles do not interfere with each other.

And in the above-mentioned embodiment, it has been described that an aligning piece is provided with a convex portion in the shape of a circular arc and an aligning piece bearing base is provided with a concave portion in the shape of a circular arc to be fitted onto the convex portion of the aligning piece, but an aligning piece bearing base may be provided with a convex portion in the shape of a circular arc and an aligning piece may be provided with a concave portion in the shape of a circular arc to be fitted onto the convex portion of the aligning piece bearing base.

Next, an optical axis adjusting and optical write head assembling method is described.

FIG. 23 is a side view showing a state where a heat sink having a light-emitting element array chip mounting substrate attached to it is mounted on an optical axis adjusting apparatus.

The optical axis adjusting apparatus comprises a support stand 52, stages 53, 54 being movable on the support stand 52 and a CCD camera 55 mounted on the stage 53. The stage 53 can move in the X direction being the main scanning direction of light-emitting elements (the direction perpendicular to the page face of FIG. 23) and in the Y direction perpendicular to the main scanning direction on the support stand 52, and the stage 54 can move in the Y direction on the support stand 52.

A heat sink 51 having a light-emitting element mounting substrate 50 attached to it is mounted on the stage 54, and the CCD camera 55 is adjusted in position so that it is focused on the surface of a light-emitting element mounted on the light-emitting element mounting substrate 50.

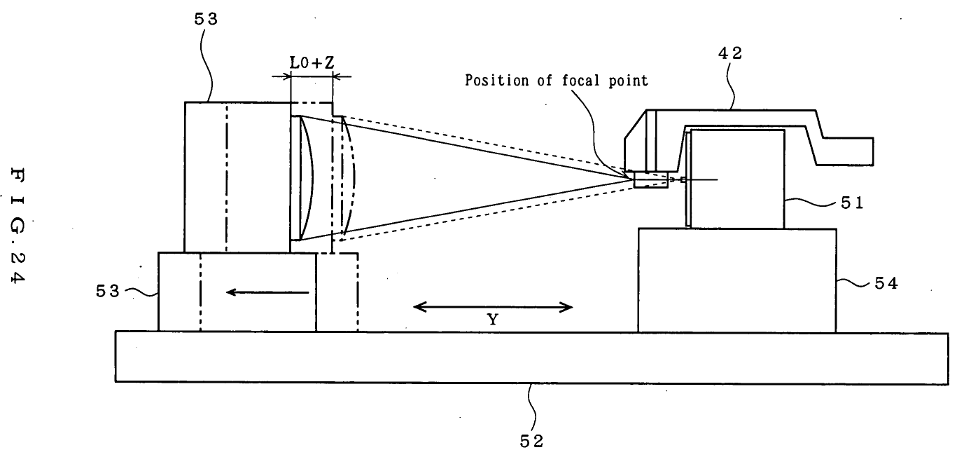

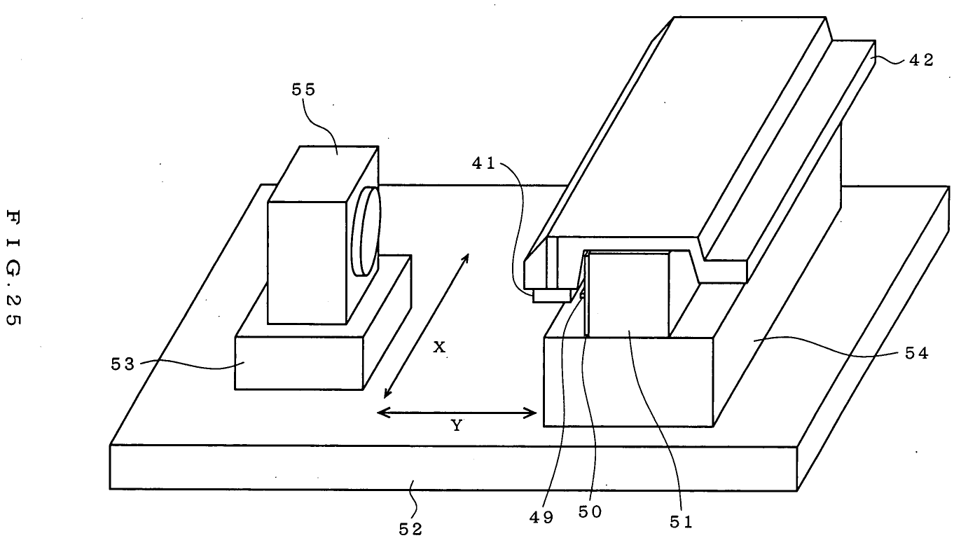

FIG. 24 is a side view showing a state where a lens-supporting member is attached to the heat sink, and FIG. 25 is a perspective view showing a state where the lens-supporting member is attached to the heat sink. This method attaches the lens-supporting member 42 having a rod lens array 41 attached to it to the heat sink 51 and slides the CCD camera 55 by a distance being an optical design value (L0+Z, where Z is the length of a rod lens) of a rod lens in the Y direction in order to adjust the working distance (L0) between the rod lens and a light-emitting element and then fixes temporarily the lens-supporting member 42 on the heat sink 51. And the method slides the lens-supporting member 42 so that the output face of the rod lens comes to the focal position of the CCD camera 55 and thereafter fixes the lens-supporting member 42 and the heat sink 51 to each other by means of bolts.

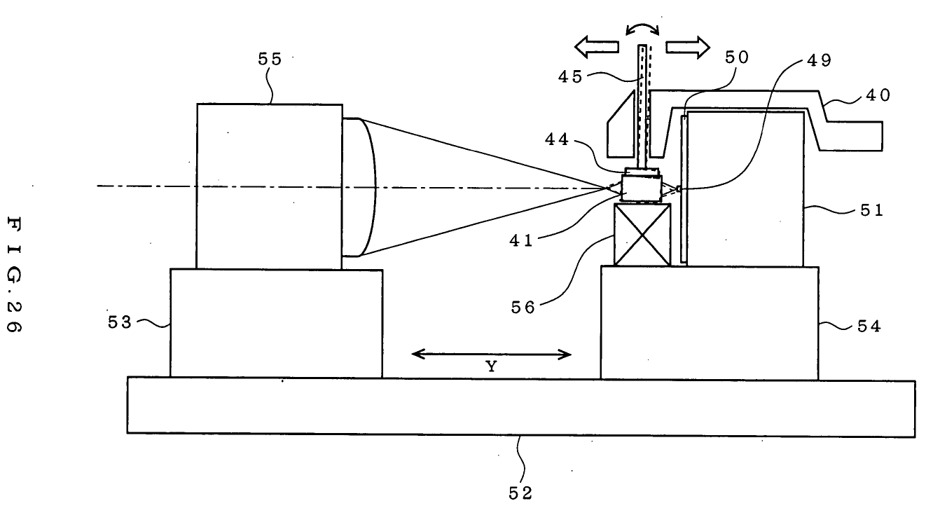

FIG. 26 is a side view showing a state where an optical write head is attached to the optical axis adjusting apparatus.

Elastic members 56 such as springs and the like are provided under the rod lens array 41 at intervals of several tens of millimeters in the longitudinal direction of the rod lens array 41, as shown in FIG. 26. The interval at which such elastic members as springs and the like are provided is preferably 20 to 65 mm.

The linearity in the longitudinal direction of the rod lens array 41 is kept by exerting the action of continuously pressing the aligning pieces of the rod lens array 41 against the aligning piece bearing bases of the lens-supporting member 42 by a load of the several tens to several hundreds of grams per 100 mm by means of these elastic members 56. The load of pressing the aligning pieces of the rod lens array 41 against the aligning piece bearing bases of the lens-supporting member 42 is preferably 50 to 250 grams per 100 mm.

The aligning piece is provided with a convex portion in the shape of a circular arc having the center of the rod lens array 41 as its center, the aligning piece bearing base is provided with a concave portion in the shape of a circular arc which has the center of the rod lens array 41 as its center and is fitted onto the convex portion of the aligning piece, and the elastic members 56 provided under the lens-supporting member 41 continuously press the aligning pieces of the rod lens array 41 against the aligning piece bearing bases of the lens-supporting member 42, and therefore the working distance of lens is kept constant in spite of sliding the aligning pieces to perform angular adjustment of the rod lenses by means of the adjusting poles 45.

The CCD camera 55 is focused on the position of spatial image formation of output light passing through a rod lens, said output light being emitted by a light-emitting element turned on of the light-emitting element array chip 49. The linearity of position of spatial image formation can be improved by sliding the stage 53 of the CCD camera 55 at specific intervals in the X direction being the main scanning direction of the light-emitting elements (the direction perpendicular to the page face of FIG. 26) and each time compensating for a slippage of the position of spatial image formation in the sub scanning direction through moving the adjusting poles 45 of the adjusting plates 44.

In order to fix the lens-supporting member 42 and the rod lens array 41 to each other after finishing compensation for a slippage of the position of spatial image formation in the sub direction, this method injects a UV hardening adhesive agent into through holes 47 in which adjusting poles 45 of the lens-supporting member 42 are through and then hardens the adhesive agent by performing a UV irradiation and thereby fixes the adjusting plates 44 and the lens-supporting member 42 to each other.

The lens-supporting member 42 and the rod lens array 41 may be fixed to each other by pouring and adhesively hardening an adhesive agent being low in viscosity onto the abutting faces of the aligning pieces 43 and the aligning piece bearing bases 46.

After the adhesive agent has been hardened, the method cuts the adjusting poles 45 projecting from the through holes 47 of the lens-supporting member 42 of means of a tool.

Next, a variation example of the second embodiment is described.

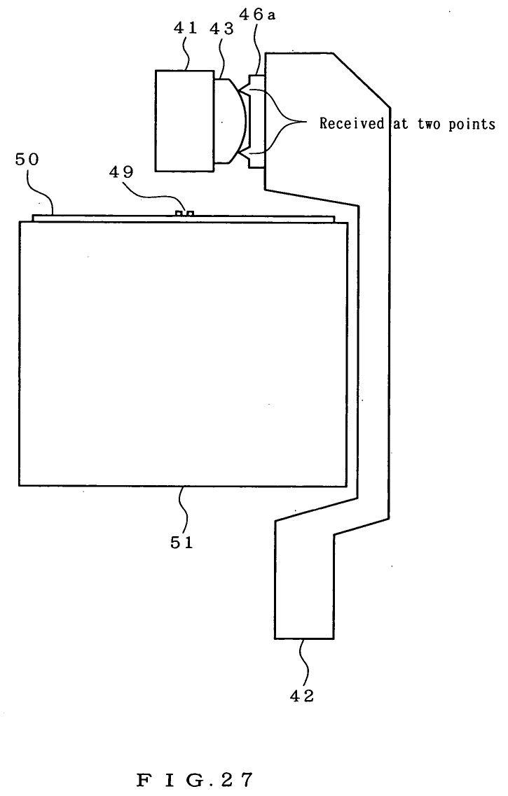

FIG. 27 shows an aligning piece provided with a convex portion and an aligning piece bearing base provided with two or more projections. As shown in FIG. 27, the aligning piece bearing base 46a may be provided with two or more projections (two projections in FIG. 27) and support the aligning piece 43 at two or more points (two points in FIG. 27). A structure which supports the aligning piece 43 at two or more points functions also similarly to an aligning piece bearing base having a concave portion in the shape of a circular arc.

An aligning piece bearing base provided with a convex portion may be supported at two or more points by an aligning piece provided with two or more projections.

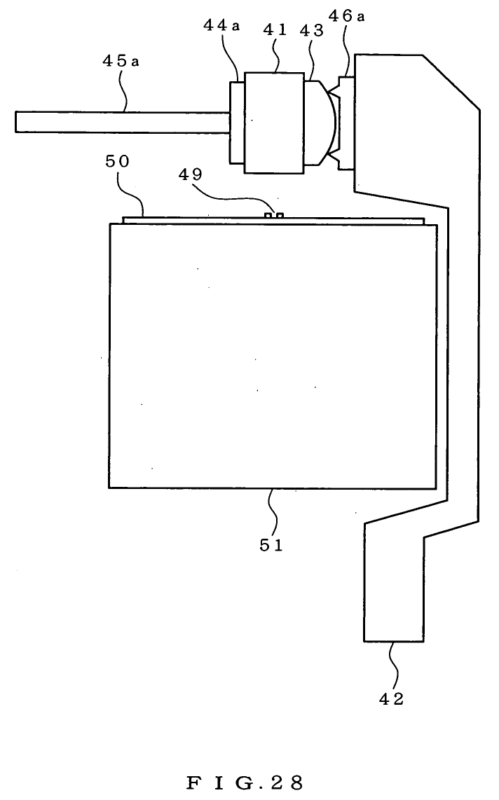

FIG. 28 shows a structure in which an adjusting plate is provided at the opposite side to an aligning piece. An adjusting plate 44a provided with an adjusting pole 45a may be provided on the opposite face to a face having an aligning piece 43 attached to it of a rod lens array 41. In FIG. 28, an aligning piece bearing base 46a provided with two projections supports an aligning piece 43 at two points, but it is a matter of course that a concave portion provided on an aligning piece bearing base 46a may be fitted onto a convex portion of an aligning piece 43.

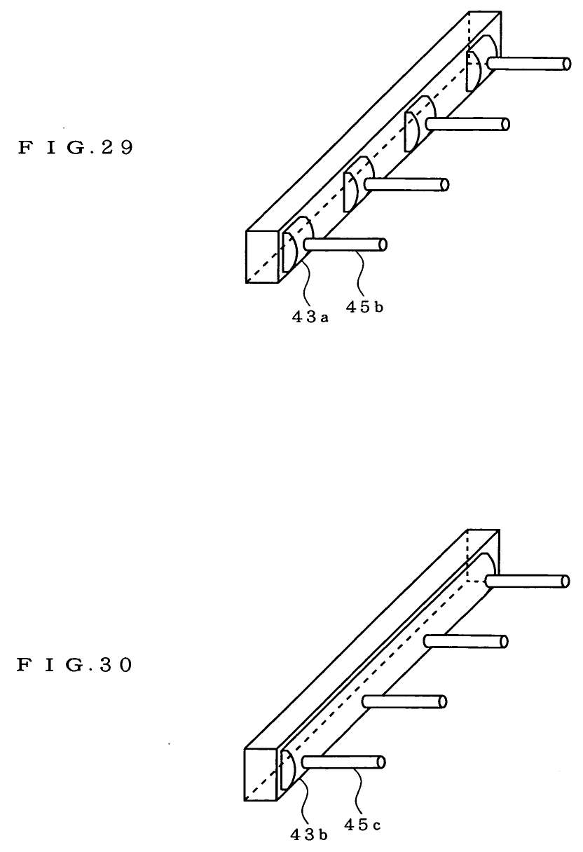

FIG. 29 shows a structure in which an aligning piece and an adjusting plate are made into one body. As shown in FIG. 29, an aligning piece 43a made into one body with an adjusting plate is adhesively fixed on a side face of a rod lens array 41 at the central part in the optical axis direction of the rod lens array 41 and is provided with an adjusting pole 45b in the middle part of the aligning piece 43a. In this case, a through hole for receiving an adjusting pole is provided in an aligning piece bearing base at a position being opposite to the aligning piece 43a.

FIG. 30 shows a structure in which a continuous aligning piece is provided. As shown in FIG. 30, a continuous aligning piece 43b is provided and adjusting poles 45c are provided at specific intervals on the aligning piece 43b. In this case, a through hole for receiving an adjusting pole is provided in an aligning piece bearing base being opposite to the aligning piece 43b. A continuous aligning piece bearing base may be provided or aligning piece bearing bases may be provided at specific intervals.

Since the invention related to the above-mentioned second embodiment makes it possible to comparatively easily perform an angular adjustment of a rod lens array and accurately determine a lens working distance (distance from a light-emitting element array to the end face of a rod lens array) at that time, the linearity of position of spatial image formation is improved and the optical design distance of a lens is kept, and thereby a high resolution can be kept. And in case that this invention is applied to a tandem printer, it is possible to easily perform registration of the respective colors and obtain a printing quality being excellent in color reproducibility.

Next, a third embodiment of the present invention is described with reference to the drawings.

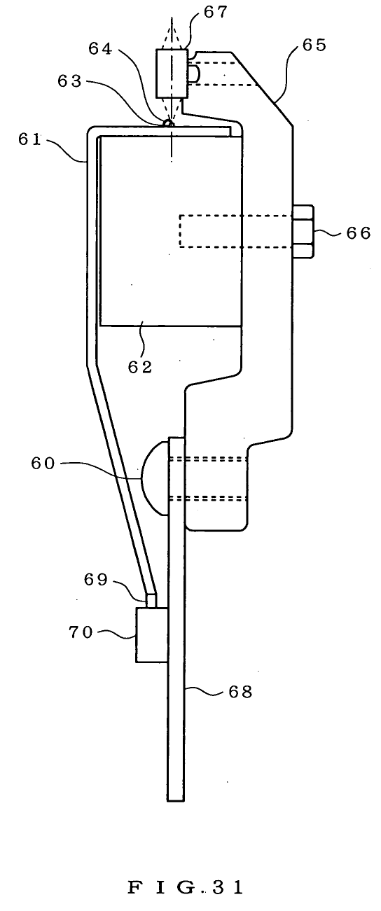

FIG. 31 is a sectional view showing a third-embodiment of an optical write head of the present invention taken along a direction perpendicular to the longitudinal direction of the head.

One end of FPC (Flexible Printed Circuit: flexible substrate) 61 is made to adhere to a heat sink (metal block) 62. A light-emitting element array chip 63 is die-bonded to FPC 61, and the wiring of FPC 61 and the electrode pads of the light-emitting element array chip 63 are connected to each other by wire-bonding using wire 64. The heat sink 62 is attached to a lens-supporting member 65 by means of bolts 66 and the like. A driver substrate 68 is attached to the lens-supporting member 65 by means of bolts 60 and the like. The FPC 61 and the driver substrate 68 are electrically connected together by joining a connector terminal 69 provided on the other end of the FPC 61 to a connector 70 of the driver substrate 68. And a rod lens array 67 is fixed, at a position being on the optical axis of the light-emitting element array chip 63, on the lens-supporting member 65.

Since the structure of the heat sink 62 may be simply rectangular, a metal material suitable for cutting and grinding can be used for the heat sink 62.

In the third embodiment, since a metal material can be used for the heat sink 62 and the lens-supporting member 65, this embodiment is hard to be influenced by variation in performance due to a temperature change around the head.

And since an optical write head shown in FIG. 31 is to be used in an electrophotographic printer of high resolution, it is necessary to make a slippage of the light-emitting element array chip 63 in a direction perpendicular to the main scanning direction be ±30 μm or less and to perform alignment with high accuracy so that the rod lens array 67 and the light-emitting element array chip 63 on the FPC 61 coincide in optical axis with each other, and therefore in the third embodiment the alignment of the FPC 61 with the heat sink 62 is an important point.

The third embodiment performs alignment of the FPC 61 with the heat sink 62, for example, by providing reference holes at specific intervals on both of them and by making the reference holes coincide with each other.

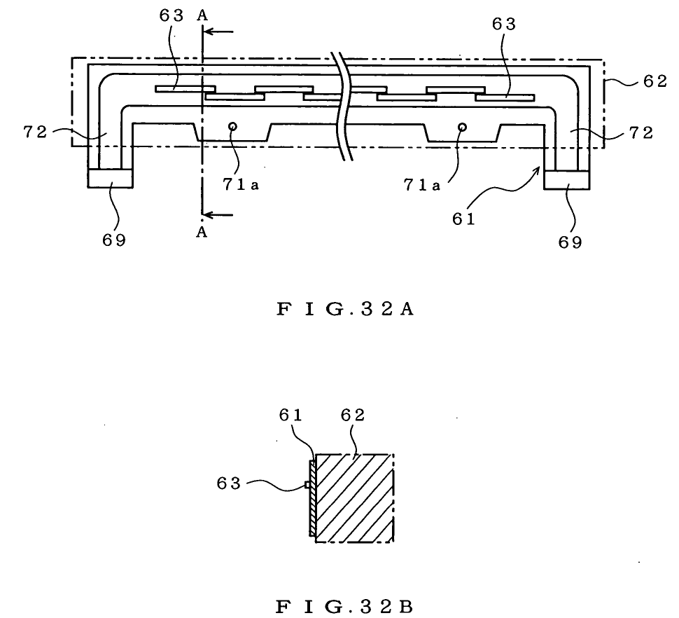

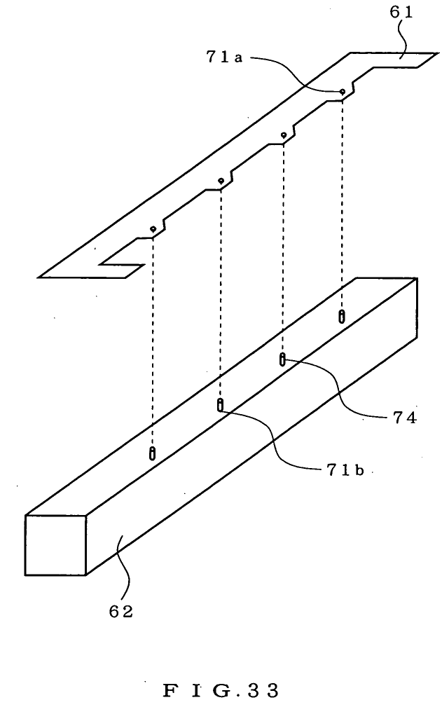

FIG. 32A is a plan view showing a state where an FPC is attached to a heat sink and FIG. 32B is a sectional view taken along line A-A′ of FIG. 32A. And FIG. 33 is a perspective view showing an example of a method of aligning an FPC with a heat sink.

As shown in FIG. 32A, a wiring pattern 72 is formed on an FPC 61 and a connector terminal 69 for joining to a connector 70 is formed at an end of the wiring pattern 72. Light-emitting element array chips 63 are arranged in zigzag in the main scanning direction on the wiring pattern 72 of the FPC 61. And reference holes 71a for aligning the FPC 61 with the heat sink 62 are provided at specific intervals along the longitudinal direction of the FPC 61 outside the wiring pattern 72.

As shown in FIG. 33, the heat sink 62 is also provided with reference holes 71b being the same in diameter as the reference holes 71a at the same intervals as the reference holes 71a of the FPC 61. When the FPC 61 is made to adhere to the heat sink 62, reference pins 74 are inserted into the reference holes 71b and inserted into the reference holes 71a of the FPC 61, and the FPC 61 is attached to the heat sink 62.

The interval between the reference holes 71a or 71b needs to be within 30 mm in order to keep the accuracy of mounting a light-emitting element array chip within ±30 μm in a direction perpendicular to the main scanning direction.

A reference hole 71a provided in the heat sink 62 is generally a circular pit but may be in any shape.

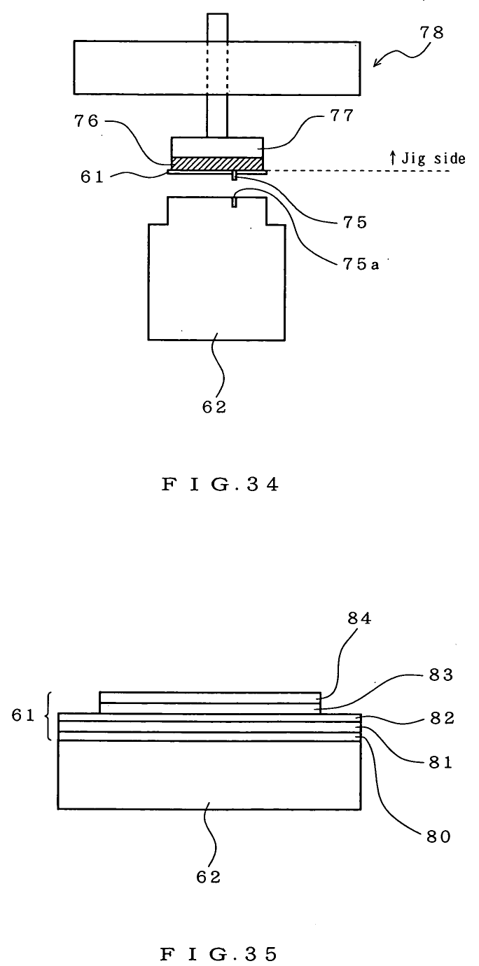

FIG. 34 is a schematic sectional view of a jig, an FPC and a heat sink showing another example of an aligning method.

In FIG. 34, this method inserts and positions a reference pin 75 provided on a jig 78 into a reference hole 75a of a heat sink 75 and then inserts the reference pin 75 into a reference hole of an FPC 61 and attaches the FPC 61 to an intermediate plate 77 of the jig 78 through a rubber 76 and lowers the intermediate plate 77 to make the FPC 61 adhere closely to the heat sink 62.

By attaching the FPC 61 to the heat sink 62 by the aligning method described above and putting the FPC 61 and the heat sink 62 into an oven of 150° C. as keeping them adhering closely to each other, a thermosetting adhesive agent laminated beforehand on the heat sink joining face of the FPC 61 is molten and hardened and thereby the FPC 61 and the heat sink 62 are adhesively fixed.

FIG. 35 is a sectional view showing the structure of an FPC. As shown in FIG. 35, an FPC 61 has an adhesive agent 80 under a base film (25 μm in thickness) 81 and is made to adhere to a heat sink 62 by this adhesive agent. An adhesive agent (25 μm in thickness) 83 being on a copper leaf (18 μm in thickness) 82 is intended for sticking an overlay film (25 μm in thickness) 84 for protecting the copper leaf 82.

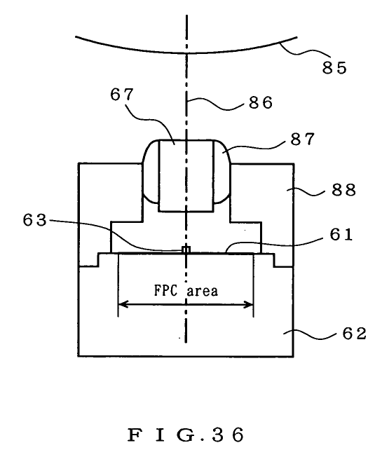

FIG. 36 shows an example of an optical write head using an FPC shown in FIG. 32A. FIG. 36 is a sectional view of an optical write head taken along a direction perpendicular to the main scanning direction of the head. A light-emitting element array chip 63 is mounted on an FPC 61 and a rod lens array 67 being on the optical axis 86 of light emitted by this light-emitting element array chip 63 is fixed through a silicone filler 87 to a plastic cover 88, and a photosensitive drum 85 is provided above the rod lens array 67. And space is provided over the heat sink 62 outside both ends of the FPC 61 in a direction perpendicular to the main scanning direction of the optical write head, and the FPC 61 is in no contact with the plastic cover 88.

The reason why the FPC 61 is made to be in no contact with the plastic cover 88 by providing space outside both ends of the FPC 61 is that since a part having a pattern and a part having no pattern in the FPC 61 are different from each other in thickness of the FPC itself, in case of attaching the plastic cover 88 in contact with the FPC 61, some undulation in the scanning direction appears in the plastic cover itself and the distance between the light-emitting element array chip 63 and the rod lens array 67 varies and therefore the resolution is made irregular.

As described above, an optical write head using an FPC shown in FIG. 32A can position a light-emitting element array chip with high accuracy but needs to have reference holes arranged at intervals of 30 mm or less in the FPC in order to keep the accuracy of mounting the light-emitting element array chip within ±30 μm in a direction perpendicular to the main scanning direction, and, for example, in case of sheet size A3 in Japanese Industrial Standard, the optical write head needs to have twelve reference holes (350/30) and needs an additional space in the FPC since the reference holes of the FPC are outside the wiring pattern 72, as shown in FIG. 32A. Further, since space is provided outside both ends of the FPC over the heat sink, the width of the optical write head in a direction perpendicular to the main scanning direction of the head results in being expanded.

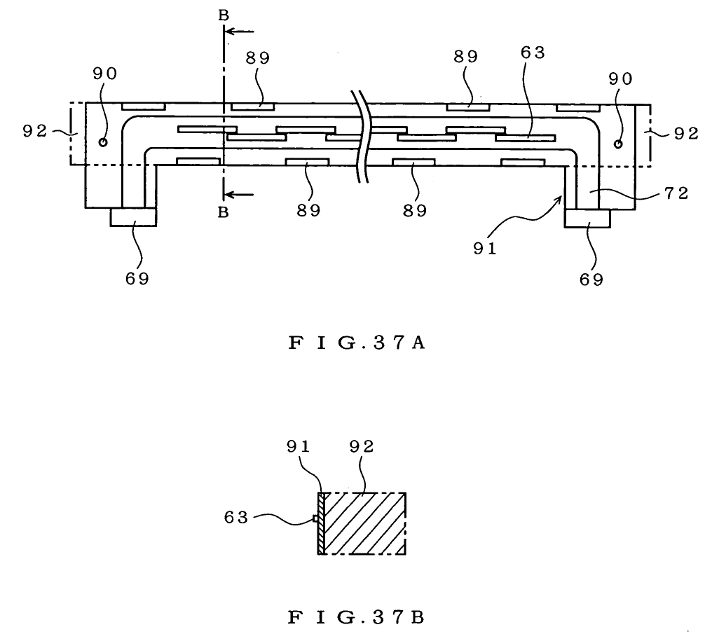

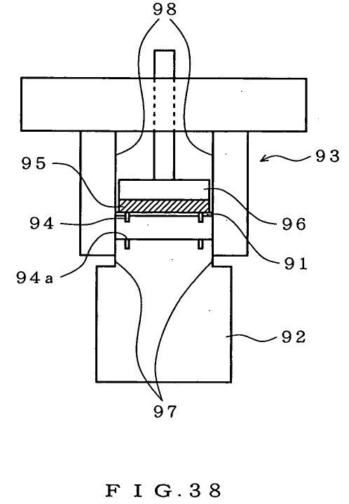

Next, a variation example of FPC is described. FIG. 37A is a plan view showing a state where an FPC is attached to a heat sink and FIG. 37B is a sectional view taken along line B-B′ of FIG. 37A. The FPC shown in FIG. 37A is provided with reference holes only at both ends in the longitudinal direction of the FPC, and thereby reduces the number of reference holes and reduces the width in a direction perpendicular to the longitudinal direction of the FPC.

As shown in FIG. 37A, reference holes 90 for alignment are provided outside a wiring pattern 72 and at both end parts in the longitudinal direction of the FPC 91, and copper leaf patterns 89 each being a metal pattern of about 0.5 mm in width are provided at specific intervals along the longitudinal direction at both end parts in a direction perpendicular to the longitudinal direction of the FPC. And a heat sink 92 is also provided with reference holes for alignment at both end parts in the longitudinal direction.

Copper leaf pattern 89 is to be a standard for aligning the FPC 91 with the heat sink 92 between the reference holes provided at both end parts in the longitudinal direction of the FPC 91 and is intended to prevent lowering of an aligning accuracy caused by twist in an end part of the FPC at the time of fitting the end parts of the FPC to an FPC aligning jig to align the FPC.

Alignment of the FPC with the heat sink is performed in the following manner.

FIG. 38 is a schematic sectional view of a jig, an FPC and a heat sink showing an example of an aligning method. An FPC aligning jig 93 is provided with a guide groove 98 for aligning an FPC 91 with a heat sink 92 by fitting an end of the FPC to the jig.

First, this method inserts and positions reference pins 94 provided on the FPC aligning jig 93 into reference holes 94a of the heat sink 92 and then inserts the reference pins 94 provided on the jig 93 into reference holes of the FPC 91 at the position of the upper dead point of an intermediate plate 96 (the point at which the intermediate plate 96 comes to the highest) and attaches the FPC 91 to the intermediate plate 96 of the jig 93 through a rubber 95.

Next, by lowering the jig 93, the fitting faces 97 of the heat sink are inserted into the jig 93 and the alignment of both of them is performed.

Next, this method makes the FPC 91 adhere closely to the heat sink 92 with a uniform surface pressure by lowering the intermediate plate 96.

Next, the FPC 91 and the heat sink fixed to the jig 93 are inserted into a heating furnace as they are kept in this state, and the FPC 91 is adhesively fixed to the heat sink 92 with a thermosetting adhesive agent of the FPC 91.

Finally, the heat sink 92 having the FPC 91 stuck on it is taken out from the jig 93.

As described above, the FPC shown in FIG. 37A is provided with reference holes 90 for alignment at both end parts in the longitudinal direction of the FPC 91 outside the wiring pattern 72, and is provided with copper leaf patterns at specific intervals along the longitudinal direction at both end parts in a direction perpendicular to the longitudinal direction of the FPC in order to prevent lowering of the aligning accuracy caused by twist of an end part of the FPC at the time of fitting and aligning the end part of the FPC with the jig.

Since these copper leaf patterns can improve the strength of an end part of the FPC, reduce twist of the end part in fitting the FPC to the jig and improve the accuracy of sticking the FPC, the FPC shown in FIG. 37A can omit many reference holes provided in the FPC shown in FIG. 32A. Thanks to this, since the FPC shown in FIG. 37A can make narrow the width in a direction perpendicular to the longitudinal direction of the FPC, an optical write head using the FPC shown in FIG. 37A can make narrow the width in a direction perpendicular to the main scanning direction of the head. And the man-hour for making reference holes can be reduced.

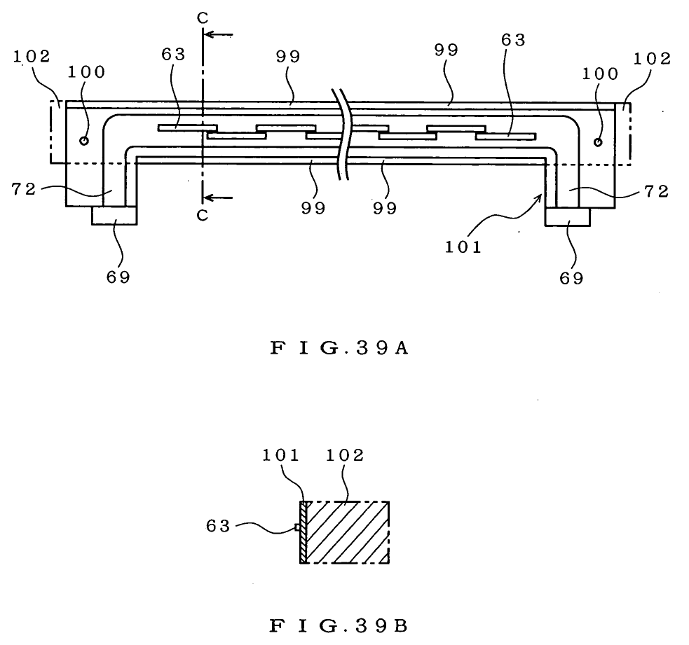

Next, another variation example of FPC is described. FIG. 39A is a plan view showing a state where an FPC is attached to a heat sink, and FIG. 39B is a sectional view taken along line C-C′ of FIG. 39A. The FPC shown in FIG. 39A is provided with copper leaf patterns each being continuous in the longitudinal direction of the FPC rather than the copper leaf patterns provided at specific intervals along the longitudinal direction of the FPC at both end parts of the FPC of FIG. 37A. The FPC shown in FIG. 39A is formed in the same way as the FPC shown in FIG. 37A except that the former is provided with copper leaf patterns each being continuous in the longitudinal direction of the FPC at both end parts of the FPC, and the former is the same as the latter also with regard to a method of aligning FPC with a heat sink.

As shown in FIG. 39A, reference holes 100 for alignment are provided outside a wiring pattern 72 and at both end parts in the longitudinal direction of the FPC 101, and continuous copper leaf patterns 99 each being a metal pattern of about 0.5 mm in width are provided along the longitudinal direction at both end parts in a direction perpendicular to the longitudinal direction of the FPC 101. And a heat sink 102 is also provided with reference holes for alignment at both end parts in the longitudinal direction.

Since the end parts of the FPC 101 are made uniform in thickness by these copper leaf patterns 99, it is possible to use the end parts of the FPC 101 as a reference plane of level at the time of mounting a plastic cover for holding a rod lens array. Therefore, since the plastic cover can be attached being in contact with the FPC 101, it is possible to make narrow the width of an optical write head in a direction perpendicular to the main scanning direction.

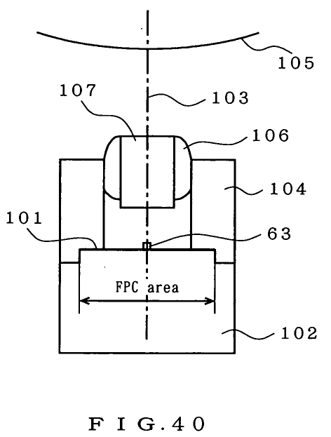

FIG. 40 shows an example of an optical write head using the FPC shown in FIG. 39A. FIG. 40 is a sectional view of the optical write head taken along a direction perpendicular to the main scanning direction. A light-emitting element array chip 63 is mounted on the FPC 101 and a lens array 107 being on the optical axis of light emitted by the light-emitting element array chip 63 is fixed through a silicone filler to a plastic cover 104. A photosensitive drum 105 is provided above the lens array 107. And the fore-end of leg of the plastic cover 104 is joined to the copper leaf patterns at the end parts of the FPC 101.

As described above, in the FPC shown in FIG. 39A, reference holes 100 for alignment are provided outside a wiring pattern 72 and at both end parts in the longitudinal direction of the FPC 101, and continuous copper leaf patterns are provided at the end parts of the FPC being portions pressed against the jig in order to prevent lowering of the aligning accuracy caused by twist of an end part of the FPC at the time of fitting and aligning the end part of the FPC with the jig.

Since these copper leaf patterns not only can improve the strength of an end part of the FPC, reduce twist of the end part at the time of fitting the FPC to the jig and improve the accuracy of sticking the FPC but also do not need to have an additional space outside the end parts of the FPC thanks to a structure in which a plastic cover overlaps the FPC by a fact that the fore-end of the leg of the plastic cover is joined to the copper leaf patterns as described above, an optical write head using the FPC shown in FIG. 39A can make narrow the width in a direction perpendicular to the main scanning direction of the optical write head in the same way as an optical write head using the FPC shown in FIG. 37A.

And since continuous copper leaf patterns are provided along the longitudinal direction of the FPC at the end parts of the FPC and are uniform in thickness, it is possible to use the upper face of the FPC as a reference plane of level at the time of mounting a plastic cover.

In each of FPCs shown in FIGS. 37A and 39A, copper leaf patterns are provided at both end parts in a direction perpendicular to the longitudinal direction of the FPC, but it is also acceptable to provide a copper leaf pattern at one end part and use the one end part as a reference level for aligning the FPC with the heat sink. And in each of FPCs shown in FIGS. 37A and 39A, reference holes are provided at both end parts in the longitudinal direction of the FPC, but it is acceptable also to provide reference holes at one end part and perform alignment by means of only the one end part.

And the FPC shown in FIG. 39A has a structure in which a plastic cover overlaps the FPC by joining the fore-end of leg of the plastic cover to the copper leaf patterns of the FPC, but in an ordinary glass-epoxy substrate it is possible also to make a plastic cover overlap the glass-epoxy substrate by coating a pattern with insulator.

As described above, since in the invention related to the third embodiment an FPC and a heat sink are provided with reference holes at the same positions in them as each other, it is possible to accurately align the FPC, namely, the light-emitting element array chip with the heat sink.

And by providing reference holes at both end parts of an FPC and a heat sink in the direction of the longitudinal direction of them and further providing copper leaf patterns at specific intervals at an edge part of the FPC, it is possible to improve the accuracy of sticking the FPC through reducing twist of the edge part at the time of fitting the FPC to a jig thanks to these copper leaf patterns and therefore make narrow the width in a direction perpendicular to the longitudinal direction of the FPC, and thus the width of an optical write head can also be made narrow. And the man-hour for making reference holes can be reduced.

Further, since a plastic cover can be made to overlap copper leaf patterns by providing continuous copper leaf patterns at edge parts of an FPC, the width of an optical write head can be also made more narrow and since the copper leaf patterns are uniform in thickness, it is possible to use the upper face of the FPC as a reference plane of level at the time of mounting the plastic cover.

Next, a self-scanning light-emitting element array chip being an example of a light-emitting element array chip used in an optical write head of the present invention is described. A self-scanning light-emitting element array chip is a light-emitting element array chip which has a self-scanning circuit built in it and has a function of transferring a light emitting spot in consecutive order.

It has been disclosed in Japanese Patent Laid-Open Publication No.Hei 1-238,962, Japanese Patent Laid-Open Publication No.Hei 2-14,584, Japanese Patent Laid-Open Publication No.Hei 2-92,650, Japanese Patent Laid-Open Publication No.Hei 2-92,651 and the like that a self-scanning light-emitting element array chip is simple and easy in mounting as a light source for a printer head, is capable of making fine the interval between light-emitting elements, and is capable of making a compact printer head, and so forth. And Japanese Patent Laid-Open Publication No.Hei 2-263,668 has proposed a self-scanning light-emitting element array chip having a structure in which a transfer element array is separated as a shift portion from a light-emitting element array being a light emitting portion.

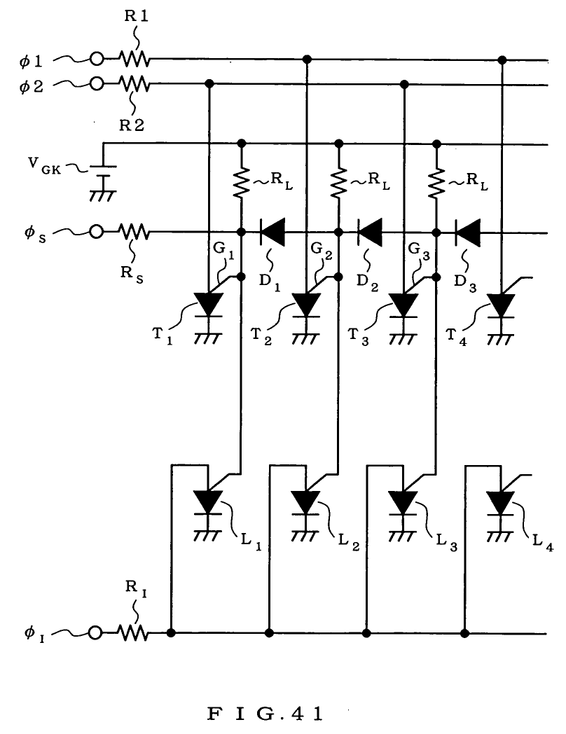

FIG. 41 shows an equivalent circuit of a self-scanning light-emitting element array chip having a structure in which a shift portion is separated from a light emitting portion. The shift portion has transfer elements T₁, T₂, T₃ and so forth, and the light emitting portion has light-emitting elements L₁, L₂, L₃ and so forth for writing. These transfer elements and light-emitting elements each are composed of a 3-terminal light emitting thyristor. The shift portion uses diodes D₁, D₂, D₃ and so forth in order to electrically connecting the gates of the transfer elements to each other. V_{GK} is a power source (ordinarily 5 V) and is connected through a load resistance R_{L} to each of the gate electrodes G₁, G₂, G₃ and so forth of the respective transfer elements. And the gate electrodes G₁, G₂, G₃ and so forth are also connected to the gate electrodes of the light-emitting elements for writing. A start pulse φ_{S} is applied to the gate electrode of transfer element T₁, clock pulses φ₁ and φ₂ for transfer are alternately applied to the anode electrodes of transfer elements, and a write signal φ_{I} is applied to anode electrodes of the light-emitting elements for writing.

In the figure, R1, R2, R_{S} and R_{I} each represent a current limiting resistor.

The operation of the self-scanning light-emitting element array chip is briefly described. First, it is assumed that the voltage of a clock pulse φ1 for transfer is at level H and transfer element T₂ is on. At this time the electric potential of gate electrode G₂ drops from V_{GK} of 5 V to about 0 V. The effect of this voltage drop is transferred to gate electrode G₃ through diode D₂, and sets its potential at about 1 V (the forward threshold voltage of D₂ (equal to a diffusion potential)). However, since diode D₁ is in an inversely-biased state, the potential is not connected to gate electrode G₁ and the potential of gate electrode G₁ is kept as it is 5 V. Since the on-state voltage of a light emitting thyristor is approximated by a diffusion potential (about 1 V) of a gate electrode potential+pn junction, if the H level voltage of the next transfer clock pulse φ₂ is set to be not lower than about 2 V (voltage necessary for turning transfer element T₃ on) and not higher than about 4 V (voltage necessary for turning transfer element T₆ on), it is possible to turn only transfer element T3 on and keep the other transfer elements in the off-state. Therefore, the on-state is transferred by two transfer clock pulses for transfer.

Start pulse φ_{S} is a pulse for starting such a transfer operation and transfer element T₁ is turned on by setting start pulse φ_{S} to level H (about 0 V) and simultaneously setting transfer clock pulse φ₂ to level H (about 2 to about 4 V). Immediately after this, start pulse φ_{S} is returned to level H.

Now, assuming that transfer element T₂ is on, the electric potential of gate electrode G₂ is about 0 V. Therefore, a write signal φ_{I} having a voltage not lower than the diffusion potential (about 1 V) of a pn junction can make the light-emitting element L₂ come into a light emitting state.

On the other hand, gate electrode G₁ is about 5 V and gate electrode G₃ becomes about 1 V. Accordingly, the write voltage of the light-emitting element L₁ is about 6 V and the write voltage of the light-emitting element L₃ is about 2 V. Thus, the voltage of a write signal φ_{I} capable of writing into only the light-emitting element L₂ is in a range of 1 to 2 V. When the light-emitting element L₂ becomes on, namely, comes into a light emitting state, the intensity of emitted light is determined by the quantity of electric current made to flow by a write signal φ_{I} and an image can be written at an optional intensity. And in order to transfer a light emitting state to the next light-emitting element, it is necessary to once turn off the light-emitting element by once dropping the voltage of a write signal φ_{I} to 0 V.

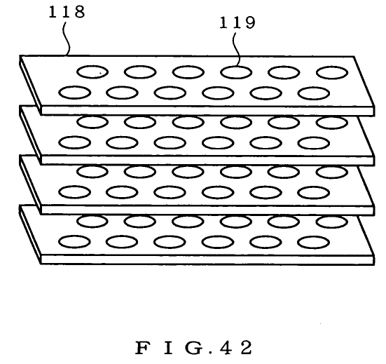

Although the above-mentioned embodiments use a rod lens array as an image forming means for forming an image on a photosensitive drum by collecting light outputted from a light-emitting element array, the present invention is not limited to a rod lens array but may use a plastic erecting unity-magnification lens array, for example. FIG. 42 is a perspective view showing an example of the configuration of a plastic erecting unity-magnification lens array. A plastic erecting unity-magnification lens array is a lens array obtained by putting two or more lens array plates 118, each of which has single lenses 119 arranged in one row or two rows, and can form an erect unity-magnification image. The single lenses 119 each have the same focal length and the same aperture, and have one convex face or both convex faces.

### Industrial Applicability

As described above, since the present invention can fix a heat sink and a lens-supporting member together at a plurality of points, it is possible to make the heat sink and the lens array into substantially one body in structure, raise the natural frequency and thereby prevent occurrence of vibration caused by resonance and the like. And it is possible also to enhance the mechanical strength of a head.

And a driver substrate is attached to a lens-supporting member, a light-emitting element mounting substrate is attached to a heat sink and further the heat sink and the lens-supporting member are in thermal contact with each other through only pull bolts and push bolts and there is substantially no thermal conduction between the heat sink and the lens-supporting member, whereby the heat energy of the driver substrate is not transmitted to the light-emitting element mounting substrate. Accordingly, it is possible to stabilize the quantity of emitted light of a light-emitting element.

And since the present invention can perform comparatively easily an angular adjustment of a rod lens array and determine accurately a lens working distance (distance from a light emitting array to the end face of a rod lens array) at that time, the linearity of position of spatial image information is improved, and the optical design distance of a lens is kept and thus a high resolution can be kept. And in case of applying the present invention to a tandem printer, it is possible to easily perform registration of the respective colors and thereby obtain a printing quality being excellent in color reproducibility.

Further, since the present invention provides an FPC and a heat sink with reference holes at the same positions in them as each other, it is possible to accurately align the FPC, namely, the light-emitting element array chip with the heat sink.

And since it is possible to improve the accuracy of sticking an FPC by providing reference holes at both end parts in the longitudinal direction of the FPC and the heat sink, providing copper leaf patterns at specific intervals at an edge part of the FPC and thereby reducing twist of the edge part at the time of fitting the FPC to a jig by means of the copper leaf patterns, it is possible to make narrow the width in a direction perpendicular to the longitudinal direction of the FPC and therefore make narrow also the width of an optical write head. And it is possible to reduce the man-hour for making reference holes.

Further, since by providing a continuous copper leaf pattern on an edge part of an FPC it is possible to make a plastic cover overlap the copper leaf pattern, it is possible to make also the width of an optical write head more narrow, and since the thickness of the copper leaf pattern is constant, it is possible to use the upper face of the FPC as a reference plane of level at the time of mounting the plastic cover.

1. An optical write head for collecting and projecting light outputted from a light-emitting element array onto a photosensitive member by means of a lens array having lenses arranged in a row, wherein;
a driver substrate having an electronic device for driving said light-emitting element array mounted on it is attached to a lens-supporting member for supporting said lens array.

2. An optical write head for collecting and projecting light outputted from a light-emitting element array onto a photosensitive member by means of a lens array having lenses arranged in a row, wherein;
said light-emitting element array is mounted on a light-emitting element mounting substrate,
said light-emitting element mounting substrate is attached to a heat sink for discharging the heat from said light-emitting element array, and
said heat sink is fixed to a lens-supporting member for supporting said lens array at specific intervals along the longitudinal direction of the lens-supporting member.

3. An optical write head for collecting and projecting light outputted from a light-emitting element array onto a photosensitive member by means of a lens array having lenses arranged in a row, wherein;
said light-emitting element array is mounted on a light-emitting element mounting substrate,
said light-emitting element mounting substrate is attached to a heat sink for discharging the heat from said light-emitting element array,
said heat sink is fixed to a lens-supporting member for supporting said lens array at specific intervals along the longitudinal direction of the lens-supporting member, and
a driver substrate having an electronic device for driving said light-emitting element array mounted on it is attached to said lens-supporting member.

4. An optical write head according to claim 3, wherein;
said heat sink is fixed to said lens-supporting member by being clamped by push bolts and pull bolts at specific intervals along the longitudinal direction of the lens-supporting member.

5. An optical write head according to claim 4, wherein;
said push bolts and pull bolts are located at the same positions as each other in the longitudinal direction of said lens-supporting member.

6. An optical write head according to claim 5, wherein;
said lens array is a rod lens array or a plastic erecting unity-magnification lens array.

7. An optical write head according to claim 3, wherein;
said heat sink is adhesively fixed to said lens-supporting member by an adhesive agent at specific intervals along the longitudinal direction of the lens-supporting member.

8. An optical write head according to claim 7, wherein;
said adhesive agent is a UV hardening adhesive agent, a moisture hardening adhesive agent, a thermosetting adhesive agent or a two-fluid hardening adhesive agent.

9. An optical write head for collecting and projecting light outputted from a light-emitting element array onto a photosensitive member by means of a lens array having lenses arranged in a row, wherein;
the optical axis of said lens is made variable in angle by providing one or two or more optical axis angle adjusting means at specific intervals in the longitudinal direction of said lens array between the abutting face of said lens array and the abutting face of a lens-supporting member for supporting said lens array.

10. An optical write head according to claim 9, wherein;
said optical axis angle adjusting means comprises
an adjusting plate for adjusting the optical axis of said lens in angle, said adjusting plate being fixed to said abutting face of said lens array,
an aligning piece being fixed to said abutting face of said lens array with a specific space relative to said adjusting plate, and
an aligning piece bearing base being fixed to said abutting face of said lens-supporting member at a position opposite to said aligning piece, wherein
said aligning piece fits into said aligning piece bearing base and is slid by an angular adjustment of said adjusting plate and thereby makes the optical axis of said lens variable.

11. An optical write head according to claim 10, wherein;
said adjusting plate comprises an adjusting pole for adjusting the optical axis of said lens in angle, and said lens-supporting member has a through hole for taking in said adjusting pole.

12. An optical write head according to claim 9, wherein;
said optical axis angle adjusting means comprises
an adjusting plate for adjusting the optical axis of said lens in angle, said adjusting plate being fixed to an opposite face to said abutting face of said lens array,
an aligning piece being fixed to said abutting face of said lens array, and
an aligning piece bearing base being fixed to said abutting face of said lens-supporting member at a position opposite to said aligning piece, wherein
said aligning piece fits into said aligning piece bearing base and is slid by an angular adjustment of said adjusting plate and thereby makes the optical axis of said lens variable.

13. An optical write head according to claim 12, wherein;
said adjusting plate comprises an adjusting pole for adjusting the optical axis of said lens in angle.

14. An optical write head according to claim 9, wherein;
said optical axis angle adjusting means comprises
an aligning piece being provided with an adjusting pole for adjusting the optical axis of said lens in angle and fixed to said abutting face of said lens array, and
an aligning piece bearing base being fixed to said abutting face of said lens-supporting member at a position opposite to said aligning piece, wherein
said aligning piece fits onto said aligning piece bearing base and is slid by an angular adjustment of said adjusting pole and thereby makes the optical axis of said lens variable.

15. An optical write head according to claim 10, wherein;
said aligning piece is provided with a convex portion in the shape of a circular arc, and
said aligning piece bearing base is provided with a concave portion in the shape of a circular arc fitting onto the convex portion of said aligning piece.

16. An optical write head according to claim 10, wherein;
said aligning piece bearing base is provided with a convex portion in the shape of a circular arc, and
said aligning piece is provided with a concave portion in the shape of a circular arc fitting onto the convex part of said aligning piece bearing base.

17. An optical write head according to claim 10, wherein;
said aligning piece is provided with a convex portion in the shape of a circular arc, and
said aligning piece bearing base is provided with two or more projections and receives said convex portion of said aligning piece at two or more points.

18. An optical write head according to claim 10, wherein;
said aligning piece bearing base is provided with a convex portion in the shape of a circular arc, and
said aligning piece is provided with two or more projections and receives said convex portion of said aligning piece bearing base at two or more points.

19. An optical write head according to claim 10, wherein;
said lens-supporting member is provided with ribs for alignment of said aligning piece bearing base at specific intervals in the longitudinal direction of said lens array.

20. An optical write head according to claim 10, wherein;
said light-emitting element array is fixed to said lens-supporting member through a light element array mounting substrate having said light-emitting element array mounted on it and a heat sink for discharging the heat from said light-emitting element array, said heat sink being attached to the lower face of said substrate.

21. An optical write head according to claim 10, wherein;
said lens array is fixed to said lens-supporting member after the optical axis of said lens is adjusted in angle.

22. An optical write head comprising a lens array on the optical axis of light emitted by a light-emitting element of a light-emitting element array and further comprising a heat sink made of a metal material under a substrate having said light-emitting element array mounted on it, wherein;
said heat sink is provided with first reference holes at specific intervals in the longitudinal direction of said heat sink, said substrate is provided with second reference holes at the same positions as said first reference holes in the longitudinal direction of said substrate, and said first reference holes and said second reference holes are aligned with each other so that the optical axis of said lens array and the optical axis of said light-emitting element array on said substrate coincide with each other.

23. An optical write head comprising a lens array on the optical axis of light emitted by a light-emitting element of a light-emitting element array and further comprising a heat sink made of a metal material under a substrate having said light-emitting element array mounted on it, wherein;
said heat sink is provided with first reference holes at both end parts in the longitudinal direction of said heat sink, said substrate is provided with second reference holes at both end parts in the longitudinal direction of said substrate and metal patterns at specific intervals at an edge part of said substrate, and said first reference holes and said second reference holes are aligned with each other so that the optical axis of said lens array and the optical axis of said light-emitting element array on said substrate coincide with each other.

24. An optical write head comprising a lens array on the optical axis of light emitted by a light-emitting element of a light-emitting element array and further comprising a heat sink made of a metal material under a substrate having said light-emitting element array mounted on it, wherein;
said heat sink is provided with first reference holes at both end parts in the longitudinal direction of said heat sink, said substrate is provided with second reference holes at both end parts in the longitudinal direction of said substrate and a continuous metal pattern at an edge part of said substrate, and said first reference holes and said second reference holes are aligned with each other so that the optical axis of said lens array and the optical axis of said light-emitting element array on said substrate coincide with each other.

25. An optical write head according to one of claims 1 to 24, wherein said light-emitting element array is a self-scanning light-emitting element array.

26. An optical write head according to claim 25, wherein said lens array is a rod lens array or a plastic erecting unity-magnification lens array.

27. A method for assembling an optical write head comprising a lens array on the optical axis of light emitted by a light-emitting element of a light-emitting element array and further comprising a heat sink made of a metal material under a substrate having said light-emitting element array mounted on it, said method comprising the steps of;
providing said heat sink with first reference holes at specific intervals in the longitudinal direction of said heat sink, providing said substrate with second reference holes at the same positions as said first reference holes in the longitudinal direction of said substrate, and aligning said first reference holes and said second reference holes with each other so that the optical axis of said lens array and the optical axis of said light-emitting element array on said substrate coincide with each other.

28. A method for assembling an optical write head comprising a lens array on the optical axis of light emitted by a light-emitting element of a light-emitting element array and further comprising a heat sink made of a metal material under a substrate having said light-emitting element array mounted on it, said method comprising the steps of;
providing said heat sink with first reference holes at both end parts in the longitudinal direction of said heat sink, providing said substrate with second reference holes at both end parts in the longitudinal direction of said substrate and metal patterns at specific intervals at an edge part of said substrate, and aligning said first reference holes and said second reference holes with each other so that the optical axis of said lens array and the optical axis of said light-emitting element array on said substrate coincide with each other.

29. A method for assembling an optical write head comprising a lens array on the optical axis of light emitted by a light-emitting element of a light-emitting element array and further comprising a heat sink made of a metal material under a substrate having said light-emitting element array mounted on it, said method comprising the steps of;
providing said heat sink with first reference holes at both end parts in the longitudinal direction of said heat sink, providing said substrate with second reference holes at both end parts in the longitudinal direction of said substrate and a continuous metal pattern at an edge part of said substrate, and aligning said first reference holes and said second reference holes with each other so that the optical axis of said lens array and the optical axis of said light-emitting element array on said substrate coincide with each other.
